(19) United States
(12) Patent Application Publication
(10) Pub. No.: US 2011/0231452 A1
(43) Pub. Date: Sep. 22, 2011

(54) STORAGE SYSTEM AND RESOURCE MANAGEMENT METHOD FOR STORAGE SYSTEM

(75) Inventors: Noriko Nakajima, Machida (JP); Yuichi Taguchi, Sagamihara (JP); Yoshiki Kano, Yokohama (JP)

(73) Assignee: HITACHI, LTD., Tokyo (JP)

(21) Appl. No.: 12/682,697

(22) PCT Filed: Mar. 19, 2010
(86) PCT No.: PCT/JP2010/002010

§ 371 Date: Apr. 12, 2010

(51) Int. Cl. G06F 17/30

(52) U.S. Cl. 707/803; 707/E17.005; 707/E17.044

(57) ABSTRACT

Log manipulation by a first administrator is prevented so that the reliability of system auditing can be improved.

After receiving a service start request from a management computer, a storage subsystem creates a first resource group regarding which access by a host computer is permitted, and also creates a second resource group regarding which access by the management computer is permitted. The storage subsystem further creates a data storage area, to which data is to be written by the host computer, and makes the data storage area belong to the first resource group, while it also creates a log storage area, in which log information indicating past operation performed on the data storage area by the host computer is to be recorded, and makes the log storage area belong to the second resource group.

### TECHNICAL FIELD

The present invention relates to a storage system and a resource management method for the aforementioned storage system. In particular, the present invention is suited for use in a storage system that incorporates a technique for preventing the manipulation of audit target data by unauthorized administrators.

### BACKGROUND ART

Recently, because of the development of network technology, a technique called Storage Area Network has been being used in which one or more computers are connected to one or more external storage devices. This Storage Area Network (hereinafter abbreviated as SAN) is setup as a computer system whereby multiple computers collaborate to provide a specific function. Alternatively, an external storage device can also be shared by a plurality of computers. This SAN type arrangement enables easy addition, deletion, or replacement of storage resources and computer resources at a later time and has the advantage of excellent extensibility.

A disk array device is generally used as the external storage device connected to the SAN. The disk array device is a device with a large number of magnetic disk drives represented by hard disk drives. The disk array device manages several magnetic disk drives together using the RAID (Redundant Array of Independent Disks) technology. This set of magnetic disk drives is called a RAID group. The RAID group constitutes one or more logical storage areas. A computer connected to the SAN processes data I/O from and to this storage area. When recording data in the storage area, the disk array device records redundant data in one or more magnetic disk drives among those constituting the RAID group. As a result, since such redundant data exists, even if one magnetic disk drive fails, the disk array device has the advantage of capability to restore data from the remaining magnetic disk drives in the RAID group.

Recently, there is a technique called Continuous Data Protection (CDP) developed as a data protection method. The CDP always audits the writing of data to a storage subsystem by a host computer at a user site and records the history of the data write every time the host computer writes data to the storage subsystem, so it is possible to restore data to a certain point in time in the past. Since past logs (journals) are recorded when using this CDP technique, it is possible to detect unauthorized activity.

Incidentally, there are a before-journal method and an after-journal method as part of the above-described CPD technique. The before-journal method restores data by saving pre-updated data as a journal and writing the journal back to the data storage area. On the other hand, the after-journal method restores data by copying data from the data storage area up to a certain point of time in the past and later adding subsequently updated data (journal) after the time of copying the updated data(see Patent Literature 1).

There is also a logical division technique that logically divides a storage subsystem in order to provide adequate storage resources and I/O performances to the many host computers deployed. With this technique, it is possible to enable a host computer and another storage subsystem connected to the storage subsystem recognize as if a plurality of logical storage subsystems having storage resources and cache memory, which are different from those on the storage subsystem, exist in that storage subsystem. As a result, appropriate storage resources can be allocated for the plurality of existing host computers and I/O performances can be improved (see Patent Literature 2).

### Citation List

### Patent Literature

PTL 1: Japanese Patent Laid-Open (Kokai) Application Publication No. 2005-18738
PTL 2: Japanese Patent Laid-Open (Kokai) Application Publication No. 2005-222123

### SUMMARY OF INVENTION

### Technical Problem

Recently, the importance of in-house system audits has been heightened due to changes in the management environment of companies. In particular, this is due to the arrival of the information age, along with the rapid development of communication technology A conventional information system using the aforementioned CDP technique can detect unauthorized operations by recording log information; however, there is also a possibility that an administrator at a user site (hereinafter referred to as first administrator) may manipulate such log information. Therefore, the accuracy of a system audit by an external auditing organization may be at risk.

The present invention was devised with the circumstances described above in mind and aims at providing a storage system together with a storage system resource management method capable of preventing such manipulation of logs by the first administrator thus improving the reliability of the system auditing.

### Solution to Problem

In order to solve the above-described problem, the present invention provides a storage system comprising: a storage subsystem for providing a host computer operated by a user and a first administrator as a user administrator, with storage areas via a network; and a management computer operated by a second administrator; wherein the storage subsystem includes: a resource group management unit for, after receiving a service start request from the management computer, creating a first resource group, regarding which access by the host computer is permitted, while creating a second resource group regarding which access by the management computer is permitted; and a storage area configuration management unit for creating a data storage area, to which data is to be written by the host computer, and making the data storage area belong to the first resource group, while creating a log storage area, in which log information indicating past operation performed on the data storage area by the host computer is to be recorded, and making the log storage area belong to the second resource group. For terminology purposes, if a site including the host computer with a user and the first administrator (also called a user site) exists, the term, second administrator, refers to the administrator of another site existing separately from the user site (also called a service provider site).

The present invention also provides a resource management method for a storage system including: a storage subsystem for providing a host computer operated by a user and a first administrator as the user administrator, with storage areas via a network; and a management computer operated by a second administrator; the resource management method including: a resource group management step executed by the storage subsystem, after receiving a service start request from the management computer, for creating a first resource group, regarding which access by the host computer is permitted, while creating a second resource group regarding which access by the management computer is permitted; and a storage area configuration management step executed by the storage subsystem for creating a data storage area, to which data is to be written by the host computer, and making the data storage area belong to the first resource group, while creating a log storage area, in which past operation performed on the data storage area by the host computer is to be recorded, and making the log storage area belong to the second resource group.

### Advantageous Effects of Invention

According to the present invention, manipulation of logs by the first administrator can be prevented and the reliability of system auditing is thereby improved.

### BRIEF DESCRIPTION OF DRAWINGS

FIG. 1 is a block diagram showing an example configuration of sites and storage networks as an embodiment of the present invention.

FIG. 2 is a block diagram showing an example configuration of a storage subsystem from FIG. 1.

FIG. 3 is a block diagram showing an example configuration of a service provider host computer in a service provider site.

FIG. 4 is a block diagram showing an example configuration of a user host computer in a user site.

FIG. 5 is a block diagram showing an example configuration of a virtual computer.

FIG. 6 is a block diagram showing an example configuration of a management computer.

FIG. 7 is a logical configuration diagram showing an example allocation of resource groups.

FIG. 8 shows an example storage area configuration information.

FIG. 9 shows an example logical unit configuration information.

FIG. 10 shows an example resource group configuration information.

FIG. 11 shows an example role management information.

FIG. 12 shows an example differential data acquisition configuration information.

FIG. 13A shows an example of a log storage area.

FIG. 13B shows an example of a log storage area.

FIG. 14 shows an example log management information.

FIG. 15 shows an example base storage area management information.

FIG. 16 shows an example iSCSI management information.

FIG. 17 shows an example host computer storage area configuration information.

FIG. 18 shows an example virtual computer allocation information.

FIG. 19 shows an example iSCSI client information.

FIG. 20 shows an example online storage management information.

FIG. 21 shows an example user management information.

FIG. 22A shows an example of an operation screen.

FIG. 22B shows an example of an operation screen.

FIG. 23 is a flowchart illustrating an example of a resource group creation processing for a service provider administrator.

FIG. 24 is a flowchart illustrating an example of a resource group creation processing for a user administrator.

FIG. 25 is a flowchart illustrating an example of differential data recording environment creation processing.

FIG. 26 is a flowchart illustrating an example of an online storage provision start processing.

FIG. 27 is a flowchart illustrating an example of a data write processing by a before-journal method.

FIG. 28 is a flowchart illustrating an example of a data write processing by an after-journal method.

FIG. 29 is a flowchart illustrating an example of data restoration processing by the before-journal method.

FIG. 30 is a flowchart illustrating an example of data restoration processing by the after-journal method.

FIG. 31 is a flowchart illustrating an example of virtual computer provision processing.

### DESCRIPTION OF EMBODIMENTS

An embodiment of the present invention will be explained below in detail with reference to the attached drawings.

### (1) Site Configuration According to the Present Embodiment

(1-1) Entire Configuration

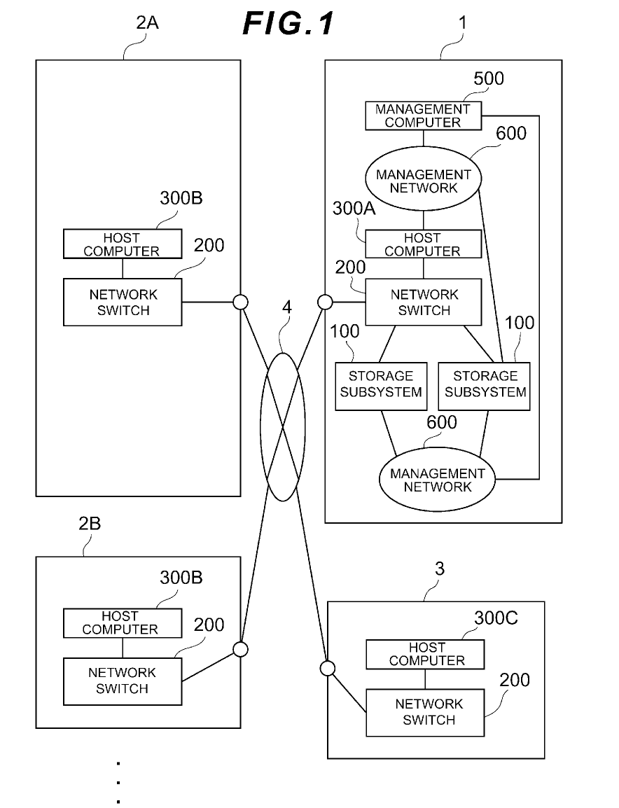

FIG. 1 shows an example of a site configuration in the present embodiment. In this site configuration, a service provider site 1, user sites 2A and 2B, and an auditing organization site 3 are mutually connected to a network via network switch 200. This site configuration provides a cloud storage service that can be audited. This also enables data input and output among the sites 1, 2A, 2B, and 3. In the present embodiment the service provider site 1 and the user sites 2A, 2B have the relationship of 1:n in terms of the number of components; the service provider site 1 and the auditing organization site 3 also have the relationship of 1:n in terms of the number of components.

The user sites 2A, 2B are examples of sites from which access to the service provider site 1 can be made. Each user site 2A, 2B is equipped with a user host computer 300B and a network switch 200. In the present embodiment, user administrators are administrators at the user sites 2A, 2B (thus they are the first administrators).

The auditing organization site 3 is installed at the organization that audits the service provider site 1. The auditing organization site 3 is equipped with an auditing host computer 300C and a network switch 200. The auditing host computer 300C is connected to network 4 via the network switch 200 and exchanges data with the service provider site 1 and other sites connected to network 4. In the present embodiment, an administrator of the auditing organization resides in site 3.

The service provider site 1 provides services to user sites 2A, 2B. In the present embodiment, a service provider administrator resides in service provider site 1. This service provider administrator is also known as the second administrator. In the present embodiment, the administrator of the auditing organization site 3 (the third administrator) may be referred to as the auditing organization administrator.

The service provider site 1 constitutes a management computer 500, at least one management network 600, a service provider host computer 300A, a network switch 200, and a plurality of storage subsystems 100. The service provider site 1 having the above-described configuration is known as a Storage Area Network (SAN).

This SAN is configured so that the service provider host computer 300A and the storage subsystems 100 are connected to each other via the network switch 200, thereby enabling mutual data input and output between the service provider host computer 300A and the storage subsystems 100. The service provider host computer 300A operates applications for, say, a database and a file server, and inputs data to, and outputs data from, storage areas. Each storage subsystem 100 has hard disk drives and provides storage areas which are units of area for storing.

The storage subsystems 100, the network switch 200, and the host computer 300 are connected to the management computer 500 via the management network 600. It should be noted that, in the present embodiment, both the management network 600 and the data I/O network comprising the network switch 200 are independent network configurations, but they may also constitute a single network configuration in other instances.

(1-2) Configuration of Storage Subsystem

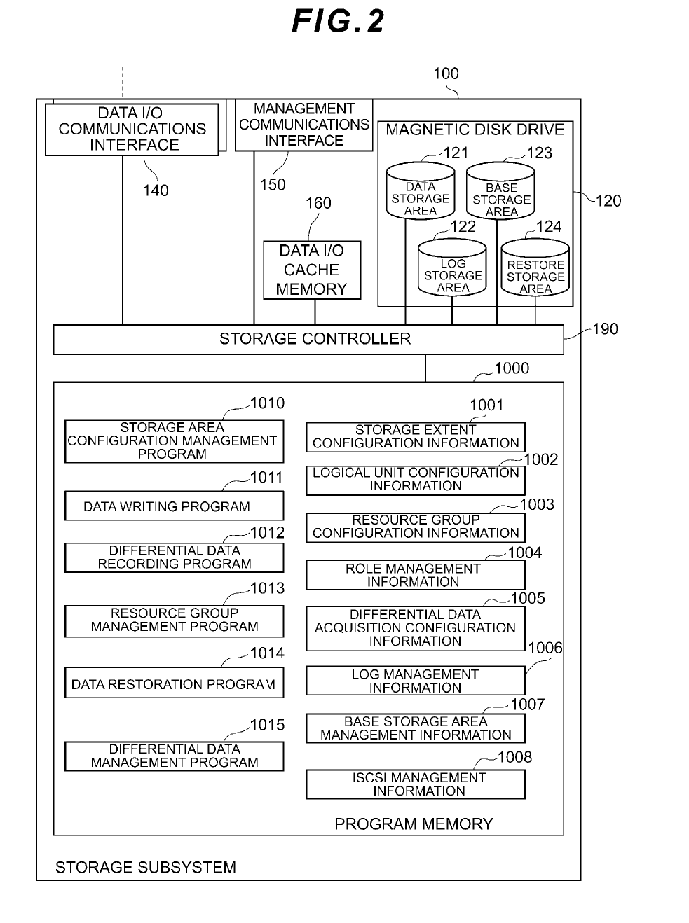

FIG. 2 shows an example configuration of the storage subsystem 100 shown in FIG. 1. The storage subsystem 100 is connected to the network switch 200 as described above via a data I/O communications interface 140 (communications interface) and is configured as described below. The storage subsystem 100 is connected, via a storage controller 190 equipped with a processor for controlling elements inside the storage subsystem 100, to the communications interface 140, the management communications interface 150, the program memory 1000, a data I/O cache memory 160, and a magnetic disk drive 120.

The management communications interface 150 is an interface for connecting to the management network and inputs/outputs management information via the management network. The storage controller 190 is equipped with a processor that controls elements inside the storage subsystem 100. The program memory 1000 is a storage space where programs necessary to operate the storage subsystem 100 are stored. The programs execute functions that will be described later. The data I/O cache memory 160 is a temporary storage area that helps to increase the input/output speed of the storage areas to the host computer 300.

The magnetic disk drive 120 has at least one data storage area 121, a log storage area 122, a base storage area 123, and a restore storage area 124. The data storage area 121 is a storage area for storing data (host write data) from the service provider host computer 300A. The log storage area 122 is a storage area for storing updated data (hereinafter referred to as the “log(s)”) from the data storage area 121. The log(s) is data obtained by a differential data recording program 1012 that will be described later. The base storage area 123 is a storage area for storing copied data from a certain point in time in the past. The restore storage area 124 is a storage area to which previous data is restored by using the logs and the copy data.

Both the communications interface 140 and the management communications interface 150 can use network I/O devices adapted to conventional communication technologies such as Fibre Channel and Ethernet. On the side note, in the present embodiment is no limitation on the number of the communications interface(s) 140 and the management communications interface(s) 150 that can be used. Incidentally, instead of having both the communications interface 140 and the management communications interface 150 as independent configurations, the communications interface 140 may be substituted for the management communications interface 150 and may also used for the purpose of inputting/outputting the management information.

The data I/O cache memory 160 is generally implemented using volatile memory, but a nonvolatile memory or a magnetic disk drive may be used as well. On the side note, in the present embodiment there is no limitation on the number and capacity of the data I/O cache memory 160.

The program memory 1000 is a memory space implemented by using a magnetic disk drive or a volatile semiconductor memory. It is used to retain basic programs and information necessary to operate the storage subsystem 100. The program memory 1000 stores control programs and control information for the storage subsystem 100.

The program memory 100 stores, as its control programs, a storage area configuration management program 1010, a data writing program 1011, a differential data recording program 1012, a resource group management program 1013, a data restoration program 1014, and a differential data management program 1015, which will be described later.

Meanwhile, the program memory 100 stores, as the control information, storage area configuration information 1001, logical unit configuration information 1002, resource group configuration information 1003, role management information 1004, differential data acquisition configuration information 1005, log management information 1006, base storage area management information 1007, and iSCSI management information 1008. These control information will be described later in detail.

The storage area configuration management program 1010 manages attributes of logical units and storage areas described later. The term, storage area(s), means, for example, the data storage area 121. This storage area configuration management program 1010 defines an LU path in accordance with instructions from the service provider host computer 300A and manages the association between the storage areas and the logical units. The term, logical unit(s), means a unit of storage resources that can be accessed by, for example, the user host computer 300B. The storage area has storage areas that can be recognized through such logical unit(s).

The data writing program 1011 is a program for writing data by designating a storage area.

The differential data recording program 1012 is a program for copying differential data. If the system uses a continuous data protection (CDP) configuration as a differential data acquisition method, the differential data recording program 1012 corresponds to a program for performing the CDP. Specifically speaking, the differential data recording program 1012 periodically copies data, which is written by the user host computer 300B to the data storage area 121, to the base storage area 123 defined as a resource group for the administrator (which corresponds to a resource group 13 described later).

After the user host computer 300B makes a data write request to write data to the data storage area 121, the differential data recording program 1012 writes updated differential data to data area 1222 in the log storage area 122 and writes log management information (sequential number, acquisition time, and storage location) about the updated differential data in header area 1221 (which is the after-journal method described earlier). Incidentally, there is also a method of CDP saving the data of data storage area 121 to the log storage area 122 when the host computer 300 makes a write request to write data to the data storage area 121 (which is the before-journal method described earlier).

The resource group management program 1013 associates the communications interface 140 with the logical units and creates a resource group that can be accessed by, for example, the host computer operated by a target person who falls under a certain user type. The definition and concept of this resource group will be described later.

After receiving a restoration request from the management computer 500, the data restoration program 1014 restores data up to a certain point in time in the past to the restore storage area 124. For example, by using the after-journal method, the data restoration program 1014 restores data at specified time in the past by copying the base storage area 123 at a certain point in time to the restore storage area 124 and writing subsequent data stored in the log storage area 122 to the restore storage area 124. Also, for example, by using the before-journal method, the data restoration program 1014 can restore data up to a specified time in the past by copying data of the data storage area 121 to the restore storage area 124, and then by writing past data before the copying time, which is stored in the log storage area 122, to the restore storage area 124.

After receiving a differential data recording environment creation command from the management computer 500, the differential data management program 1015 creates the environment to construct, for example, the CDP configuration. It should be noted that the data restoration program 1014 and the differential data management program 1015 are targeting not only the storage areas in the resource group (corresponding to the resource group 13 described later).

(1-3) Configuration of Service Provider Host Computer

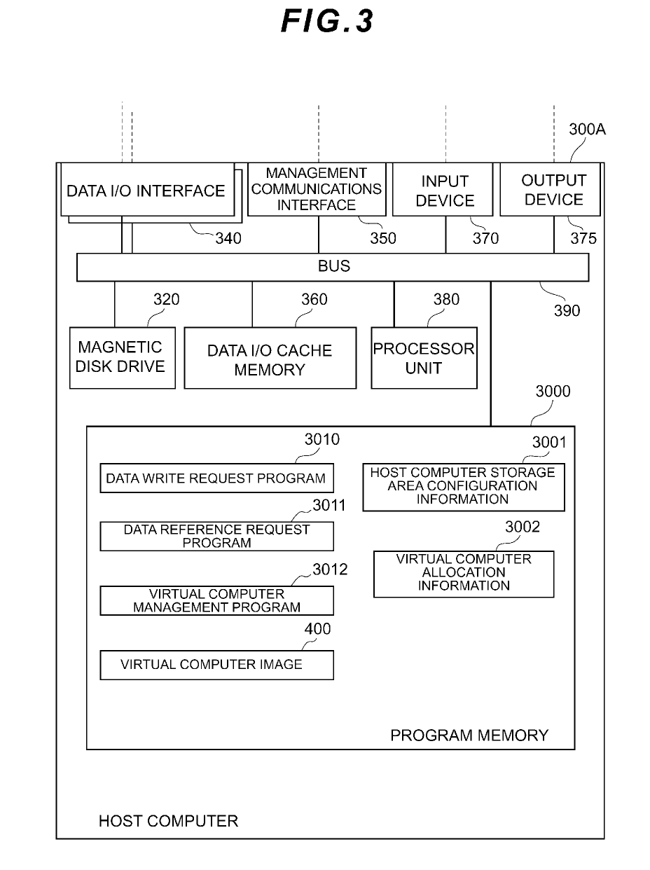

FIG. 3 shows an example configuration of the service provider host computer 300A installed at the service provider site 1. The service provider host computer 300A is configured so that data I/O interface 340, management communications interface 350, input device 370, output device 375, processor unit 380, magnetic disk drive 320, program memory 3000, and data I/O cache memory 360 are connected to each other via communication bus 390.

The data I/O interface 340 is an interface for establishing a connection with the network switch 200 to input and output data. The management communications interface 350 is an interface for establishing a connection with the management network 600 to input and output management information. The input device 370 is an interface such as a keyboard and a mouse for an operator to input information. The output device 375 is an interface such as a general purpose display for outputting information to the operator. The processor unit 380 corresponds to a CPU (Central Processing Unit) for performing various calculations. The magnetic disk drive 320 stores software such as an operating system and various applications.

The program memory 3000 stores programs necessary to operate the user host computer 300B. The data I/O cache memory 360 is a memory that helps to increase the speed of data input-output executions by storing data, which has been obtained from magnetic disk drive 320, once after every certain period of time. It can thereby provide the data immediately instead of accessing the magnetic disk drive 320 every time. Moreover, the hardware configuration of the user host computer 300B shown in this example can be achieved by using a general purpose computer.

The data I/O interface 340 and the management communications interface 350 are implemented by using network I/O devices adapted to communication technology such as Fibre Channel and Ethernet. On the side note, in the present embodiment there is no limitation on the number of data I/O interface(s) 340 and the management communications interface(s) 350. Moreover, instead of having each of the data I/O interface 340 and the management communications interface 350 as separate configurations, either one of them may be substituted for the other.

It is common to use volatile memory as the data I/O cache memory 360, but non-volatile memory or magnetic disk drives may be used instead. On the side note, in the present embodiment there is no limitation on the number and capacity of data I/O cache memory 360.

The program memory 3000 is a memory space implemented by magnetic disk drive or volatile semiconductor memory and is used to retain programs and information necessary to operate the host computer 300. The program memory 3000 stores control programs and control information described later.

Firstly, a data write request program 3010 determines the storage volume, to which data is to be written, and transmits a write request message to the communications interface 140 and the logical unit 10 within the storage subsystem 100.

A data reference request program 3011 determines a storage volume, to which data should be referred, and transmits a read request message to the communications interface 140 and the logical unit 10 in the storage subsystem 100, which are associated with this storage volume.

Virtual computer management program 3012 creates, for instance, a virtual computer 400 after receiving a virtual computer creation request from the management computer 500. The details of the virtual computer 400 will be explained later.

(1-4) Configuration of User Host Computer

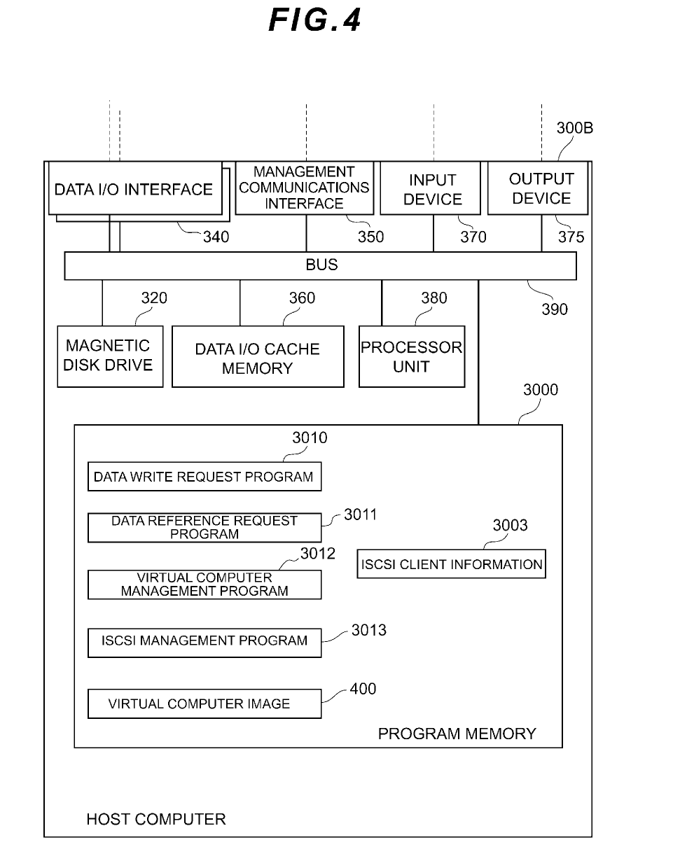

FIG. 4 shows an example configuration of the user host computer 300B installed at the user site 2A. The user host computer 300B is configured in the same manner as the service provider host computer 300A (shown in FIG. 3) with regard to various interfaces (340, 350, 370, 375), the bus 390, the magnetic disk drive 320, the data I/O cache memory 360, and the processor unit 380. The user host computer 300B has a program for establishing connection to an iSCSI interface which is necessary when sending/receiving data to/from the logical unit 10 in the storage subsystem 100 installed at the service provider site 1. The program memory 3000 stores control programs and control information described below.

An iSCSI management program 3013 is a program for associating the iSCSI communications interface 340 with an IP address.

(1-5) Configuration of Virtual Computer

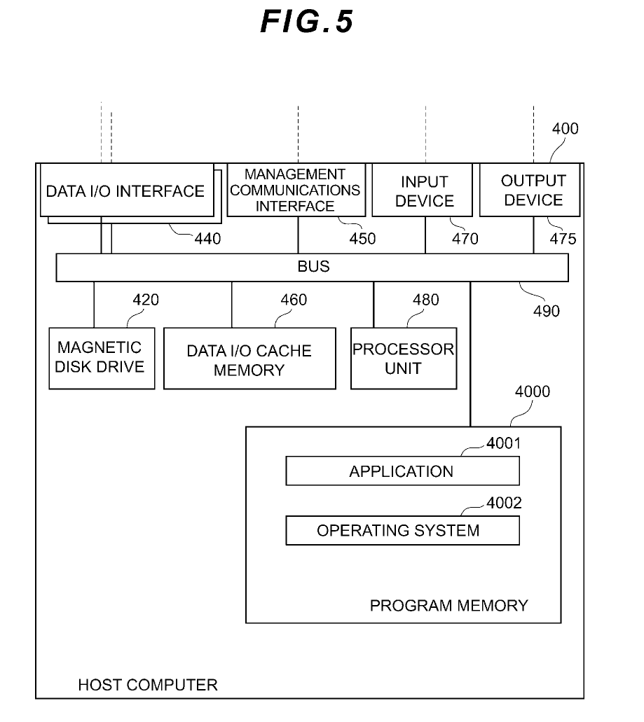

FIG. 5 shows an example configuration of the virtual computer 400. Although the reference numerals are different, the virtual computer 400 is configured in almost the same manner as the configuration of the user host computer 300B shown in FIG. 4. Program memory 4000 is a memory space implemented by magnetic disk drive or volatile semiconductor memory and includes at least an application and an operating system to be described later.

If audit target data cannot be browsed unless a specific application operating on a certain operating system is used, the virtual computer 400 is a computer image for virtually developing the operating system and the application. Part of the object of the present embodiment is to ensure the capability to audit data no matter what form the obtained audit target data is.

(1-6) Management Computer

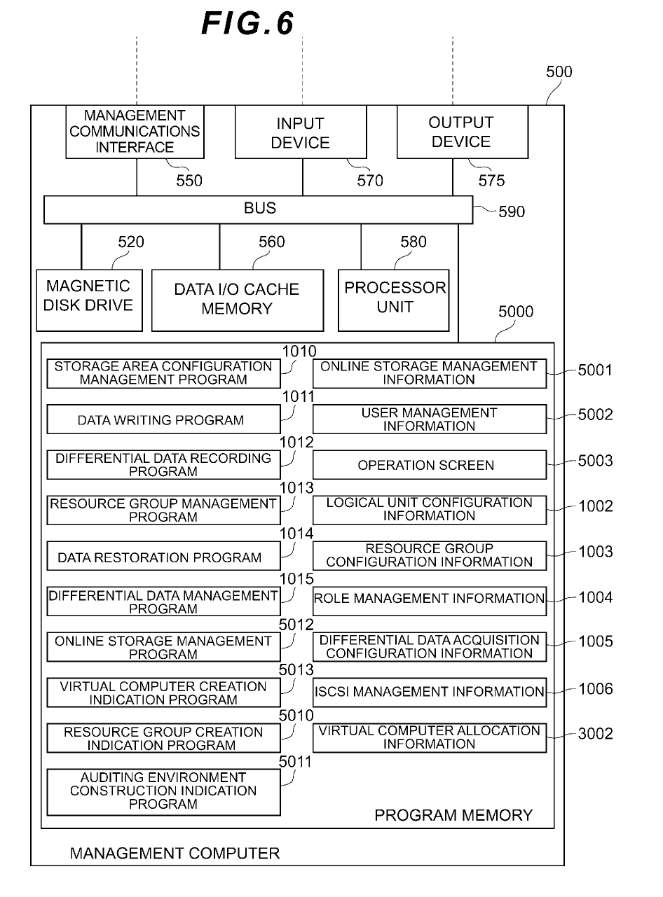

FIG. 6 shows an example configuration of the management computer 500. The management computer 500 is configured so that a management communications interface 550, an input device 570, an output device 575, a processor unit 580, a magnetic disk drive 520, and a program memory 5000 are connected via communication bus 590.

The management communications interface 550 is an interface, which is connected to management network 600, for inputting/outputting specified management information. The input device 570 is an interface such as a keyboard and mouse for the operator to input information. The output device 575 is an interface such as a general purpose display for outputting information to the operator.

The processor unit 580 corresponds to a central processing unit (CPU) for performing various calculations. The magnetic disk drive 520 stores software such as an operating system and applications. The program memory 5000 stores programs necessary to operate the management computer 500. Therefore, the hardware configuration of the management computer 500 shown in this example can be implemented by using a general purpose computer (PC).

The program memory 5000 is, for example, a magnetic disk drive or a volatile semi-conductor memory and stores programs and information necessary to operate the management computer 500. The program memory 5000 stores control programs described below and control information described later.

(1-7) Various Programs in Storage Subsystem

Firstly, a resource group creation indication program 5010 is a program for creating an area in the storage subsystem 100, which can be accessed only by a target person such as a specified user, when receiving a resource group creation request according to input to an operation screen (described later) displayed on the management computer 500. In the present embodiment, such an area which can be accessed only by a specified target person is called a resource group.

An auditing environment construction indication program 5011 gives a command to the storage subsystem 100 to create the log storage area 122 as described later when receiving a request message to construct the auditing environment in accordance with the content of input to the operation screen on the management computer 500 in the same manner as described above.

An online storage management program 5012 outputs a service start request to start online storage or a termination request to terminate the online storage to the storage subsystem 100 in accordance with the content of input to the operation screen in the same manner as described above. Incidentally, it is only necessary to execute this service start request once at the beginning. The online storage management program 5012 updates online storage management information 5001 in accordance with the output from the service start request.

A virtual computer creation indication program 5013 creates the virtual computer 400, in which a file system is virtually operated, on the service provider host computer 300A and gives a command to mount the restore storage area 124 on the file system for the virtual computer 400.

### (2) Resource Group in Entire Site Configuration

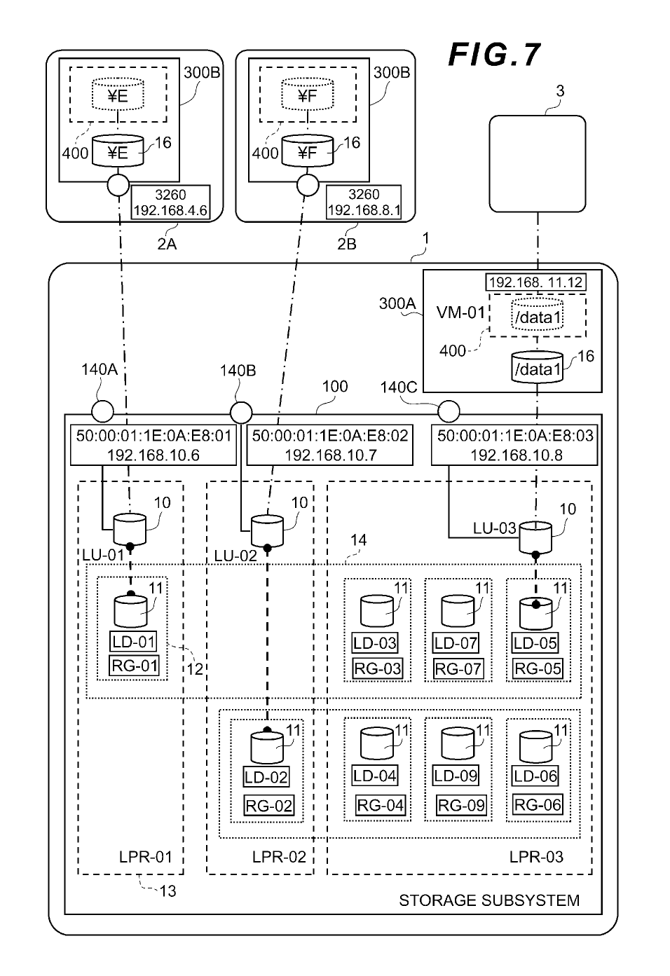

FIG. 7 is a logical diagram of resource groups in the entire site configuration. The entire site is constituted from the user sites 2A, 2B, the service provider site 1, the auditing organization site 3, and the network (not shown).

Firstly, at the user site 2A, the user host computer 300B has a data I/O interface 3260. An IP address, for example, “192.168.4.6” is assigned to this data I/O interface 3260. The user host computer 300B has a volume 16 whose name is, for example, \E.

The user site 2B has the user host computer 300B equipped with an data I/O interface 3260. An IP address, for example, “192.168.8.1” is assigned to this data I/O interface 3260. The user host computer 300B has a volume 16 whose name is, for example, \F.

The auditing organization site 3 browses the log information stored in the log storage area 122 at the service provider site 1 and audits whether the log information is manipulated or not. Furthermore, at the auditing organization site 3, data developed in the virtual computer 400 at the service provider site 1 is verified as described later.

The service provider site 1 includes, for example, the storage subsystem 100 and the service provider host computer 300A. The storage subsystem 100 includes, for example, three communications interfaces 140A, 140B, 140C.

The service provider host computer 300A has a data I/O interface and an IP address, for example, “192.168.11.12” is assigned to this data I/O interface. In this service provider host computer 300A, a volume 16 and a virtual computer 400 whose name is, for example, VM-01 are created. This volume 16 is named “/data1”; and as this volume 16 is mounted on the virtual computer 400, the virtual computer 400 is recognized externally as a virtual volume whose name is, for example, “/data1.”

Next, the storage subsystem 100 is equipped with the communications interfaces 140A, 140B, 140C, logical units 10, and storage areas 11. The storage subsystem 100 has the logical units 10 whose LU numbers are, for example, LU-01, LU-02, and LU-03.

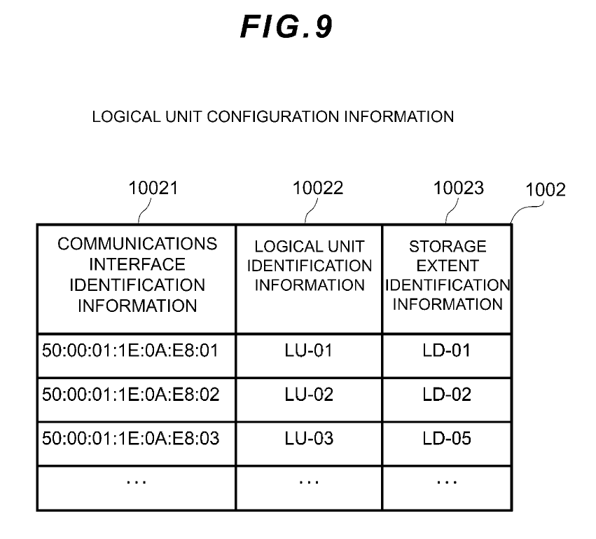

Identification information of the communications interfaces 140A, 140B, 140C is, for example, “50:00:01:1E:0A:E8:01,” “50:00:01:1E:0A:E8:02,” and “50:00:01:1E:0A:E8:03” respectively. The relationship between the communications interfaces (such as 140A), the storage areas 11, and the logical units 10 is managed by logical unit configuration information (LU identification information) shown in FIG. 9.

The storage areas 11 are associated with the logical units 10. Specifically speaking, regarding the communications interface 140A, the logical unit 10 with the LU number LU-01 is associated with the storage area 11 with the volume name LD-01 (LDEV01). Regarding the communications interface 140B, the logical unit 10 with the LU number LU-02 is associated with the storage area 11 with the volume name LD-02. Regarding the communications interface 140C, the logical unit 10 with the LU number LU-03 is associated with the storage area 11 with the volume name LD-05.

Each data I/O interface is assigned the IP address. Specifically speaking, for example, the IP addresses, 192.168.10.6, 192.168.10.7, 192.168.10.8 are assigned to the communications interfaces 140A, 140B, 140C, respectively. Meanwhile, the logical units 10 with the LU numbers LU-01, LU-02, LU-03 are associated with the IP addresses “192.168.10.6,” “192.168.10.7,” “192.168.10.8,” respectively. This correspondence relationship is managed by iSCSI management information shown in FIG. 16 described later. For example, the user site 2A can access the logical unit 10 via the communications interface 140A by designating the IP address, 192.168.10.6.

In the present embodiment, a resource group is defined to the storage area(s) 11 in the storage subsystem 100 and this resource group means a set of storage resources defined to permit access by a specified user.

In the present embodiment, three groups to which the names LPR-01, LPR-02 and LPR-03 are assigned are defined as examples of the resource groups. These three resource groups LPR-01, LPR-02, LPR-03 are associated with the plurality of communications interfaces 140A, 140B, 140C, respectively. This association is defined by resource group configuration information described later.

After the storage subsystem 100 receives a service start request from the management computer 500, the resource group management program 1013 and the storage area configuration management program 1010 execute the following processing according to the present embodiment. Specifically speaking, the resource group management program 1013 creates a first resource group 13 for the user and a second resource group 13 for the service provider administrator. It should be noted that in the present embodiment, the same reference numerals may be given to the resource groups created for the persons involved such as the user, the user administrator (first administrator), the service provider administrator (second administrator), and the auditing organization administrator (third administrator), respectively; however, the same reference numeral is given in order to collectively refer to the concept of the resource group, but not to indicate that they are the resource groups having the same configuration. Next, the storage area configuration management program 1010 creates a storage area 11 (which corresponds to the data storage area 121 described earlier), to which data is to be written by the user host computer 300B, and makes the data storage area 121 belong to the first resource group 13. Furthermore, the storage area configuration management program 1010 creates a storage area 11 (which corresponds to the log storage area 122 described earlier) for recording the log information about past operations performed by the user host computer 300B on the data storage area 121, and makes the log storage area 122 belong to the second resource group 13.

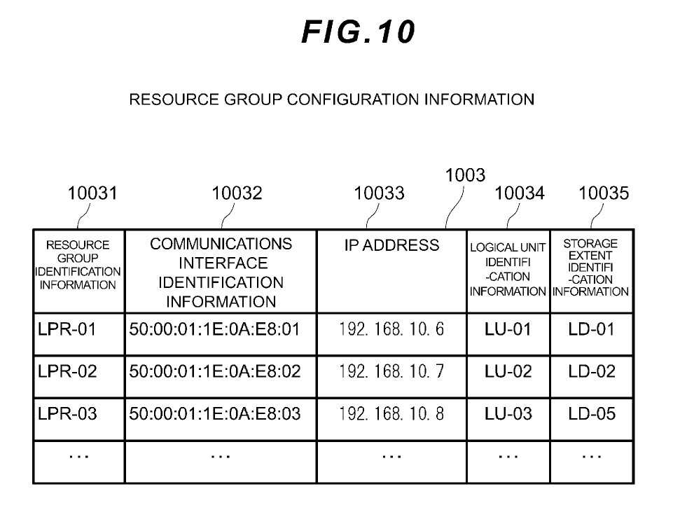

If the above-described configuration is used, the logical unit 10 corresponding to a certain resource group is configured so that it cannot be recognized from outside the storage subsystem 100 unless access is made through the intermediary of a specified communications interface allocated to that specified resource group, for example, from among the communications interfaces 140A, 140B, 140C. Therefore, the above-described storage area 11 is configured so that access to the storage area 11 via its logical unit 10 from outside the storage subsystem 100 cannot be permitted unless access is made via the communications interface having the correspondence relationship with that storage area 11. Such correspondence relationship is defined by logical unit configuration information described later (see FIG. 10).

For example, the user host computer 300B which resides at the user site 2A and is operated by a certain user is configured so that it cannot recognize the storage area 11 in a specified resource group unless it accesses the storage area 11 via the communications interface having the correspondence relationship with the specified resource group. Incidentally, since the communications interface 140A (“50:00:01:1E:0A:E8:01”) is associated with the first resource group 13 with the name “LPR-01,” it is associated with the storage area 11 with the name “LD-01” belonging to the first resource group.

Since the correspondence relationship between the first resource group 13 and the communications interface 140C is not defined, the user host computer 300B is not permitted to access three storage areas 11 with the names LD-03, LD-07, and LD-05 belonging to the second resource group. Incidentally, in the present embodiment, the three storage areas LD-03, LD-07, and LD-05 correspond to the log storage area 122, the base storage area 123, and the restore storage area 12.

This is because access to the storage resources belonging to the second resource group 13 is limited according to the present embodiment unless the storage resources overlap with the storage resources belonging to the first resource group 13 (LD-01); and only the service provider administrator is permitted to access the second resource group 13. Such an access limitation is set in order to prevent, for example, the user administrator at the user site 2A from manipulating the log information.

It should be noted that the data storage area 121, the log storage area 122, the base storage area 123, and the restore storage area 124 are associated with a differential data acquisition group that is a unit for executing a sequence of processing for obtaining differential data as described later.

### (3) Configuration of Control Information

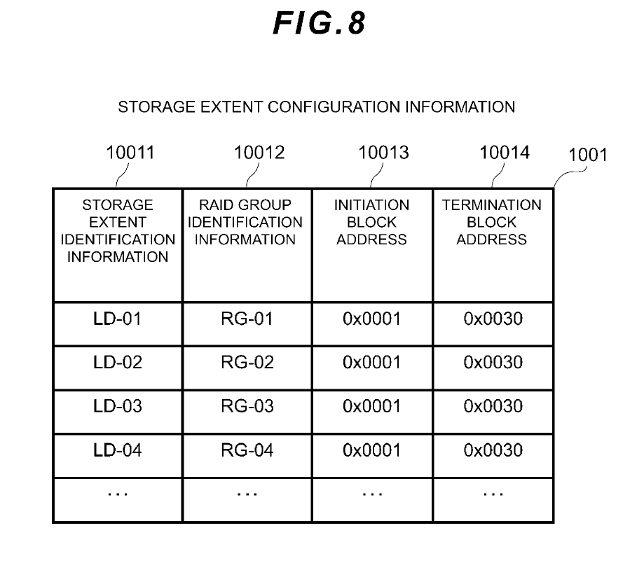

FIG. 8 is an example configuration of the storage area configuration information 1001 included in the storage subsystem 100. The storage area configuration information 1001 represents configuration information about each storage area 11. The storage area configuration information 1001 manages, for each storage area 11, storage area identification information 10011, RAID group identification information 10012, a starting block address 10013, and an termination block address 10014. The storage area identification information 10011 is a volume name for identifying each storage area 11. The RAID group identification information 10012 is information for identifying each RAID group. Incidentally, as an example of the RAID group, RG-01 and other RAID groups exist as shown in FIG. 7.

It is shown that the storage area 11 with the volume name indicated in the storage area identification information 10011 belongs to the RAID group indicated in the RAID group identification information 10012. The physical position of the storage area 11 corresponds with a physical address space on the above-mentioned RAID group, which is recorded in a storage area from the initiation block address 10013 to the termination block address 10014.

FIG. 9 shows an example configuration of the logical unit configuration information 1002 included in the storage subsystem 100. The logical unit configuration information 1002 manages communications interface identification information 10021, logical unit identification information 10022, and storage area identification information 10023.

The communications interface identification information 10021 represents information for identifying each of the communications interfaces (such as 140A, 140B, 140C) so that they can recognize each other as the communications interfaces. The logical unit identification information 10022 represents identification information for identifying each logical unit 10. The storage area identification information 10023 represents identification information for identifying the storage area 11.

The storage area 11 indicated in the storage area identification information 10023 is associated with any of the communications interfaces (such as 140A) indicated in the communications interface identification information 10021 and is also associated with the logical unit 10 indicated in the storage unit identification information 10022. The logical unit 10 is a unit of storage resources that can be accessed by the user host computer 300B connected to the storage subsystem 100. The logical unit 10 corresponds to a volume to be mounted on the file system for the user host computer 300B as described later.

FIG. 10 shows an example configuration of the resource group configuration information 1003. The resource group configuration information 1003 is provided in the storage subsystem 100 and includes resource group identification information 10031, communication interface identification information 10032, an IP address 10033, logical unit identification information 10034, and storage area identification information 10035.

The resource group identification information 10031 represents identification information for identifying each resource group. The communications interface identification information 10032 corresponds to the aforementioned communications interface identification information 10021. The IP address 10033 represents an IP address assigned to the communication interface identification information 10032. The logical unit identification information 10034 corresponds to the aforementioned logical unit identification information 10022. The storage area identification information 10035 corresponds to the aforementioned storage area identification information 10023.

The resource group indicated in the resource group identification information 10031 contains the storage area 11 indicated in the storage area identification information 10035. The storage area 11 is associated with the logical unit 10 indicated in the logical unit identification information 10034. The logical unit 10 is associated with the communication interface set to the communication interface identification information 10032.

As a result, the configuration is set so that the logical unit 10 belonging to a certain resource group cannot be accessed from outside the storage subsystem 100 to read data from, or write data to, the logical unit 10 unless access is made through the intermediary of a specified communication interface associated with the logical unit 10.

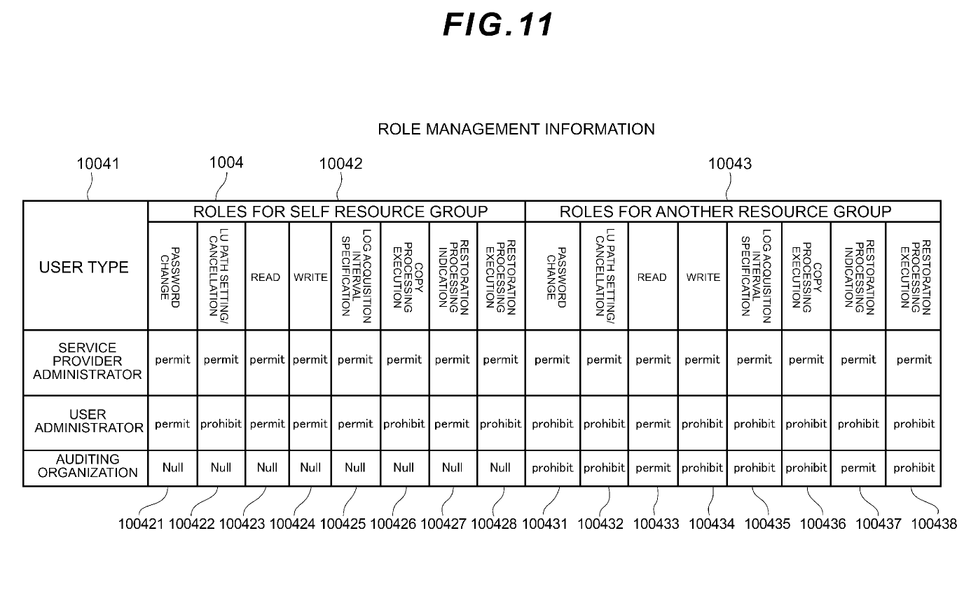

FIG. 11 shows an example configuration of the role management information 1004 included in the storage subsystem 100. The role management information 1004 shows roles for the user type described below and includes, as the roles, roles for the user's own resource group 10042 and roles for another resource group 10043. In the present embodiment, examples of the user type are a service provider administrator, a user administrator, and an auditing organization (auditing organization administrator). The user's own resource group for, for example, the first administrator (such as the user administrator), is a resource group to which the data storage area 121 created for the first administrator themselves as a data write destination belongs, and the user's own resource group for, for example, the second administrator (such as the service provider administrator) is a resource group to which the log storage area 122, the base storage area 123, and the restore storage area 124 belong. Another resource group is a resource group other than the user's own resource group as viewed from the administrator.

The user type 10041 indicates the user type. The roles for the self resource group 10042 indicate roles that are set to a resource group 13 created for the self resource group after a service start request is made. The roles for another resource group 10043 indicate roles that are set to a resource group other than the resource group created for the user's own resource group. Incidentally, if performance of each relevant role is permitted, Permit is set to the column; and if performance of each relevant role is limited, Prohibit is set to the column. Each column will be explained below.

A password change column 100421 indicates whether a password which is asked for when accessing the storage area 11 in the resource group 13 can be changed or not. An LU path setting/cancellation column 100422 indicates whether or not the logical unit 10 in the resource group can be set or cancelled. A read column 100423 indicates whether or not reference can be made to data recorded in the storage area 11 in the resource group. A write column 100424 indicates whether or not data can be written to the storage area 11 in the resource group. A log acquisition interval specification column 100425 indicates whether a copy execution interval can be selected or not. A copy processing execution column 100426 indicates whether or not it is possible to execute the processing further to parameter detail designing. For example, it is possible to execute the processing further to specify a log acquisition service level, using a log acquisition specification authority; however, actual selection of a copy method in consideration of the storage capacity, performance, and other factors of the storage subsystem 100 is left to a copy processing execution authority. Furthermore, a restoration processing indication column 100427 indicates whether a request for restoration processing can be made or not, and restoration processing execution 100428 is the authority to judge the restoration request and actually execute the restoration processing. Incidentally, the password change column 100431 to the restoration processing execution 100438 regarding the roles for another resource group 10043 indicate almost the same content as the password change column 100421 to the restoration processing execution 100428 regarding the roles for the user's own resource group 10042, except for the difference of whether the roles relate to the user's own resource group or another resource group.

According to the present embodiment, the service provider administrator of the user type 10041 has, for example, all the roles for all the resource groups. The user administrator of the user type 10041 can perform account management and data reading and writing with regard to the resources in the user's own resource group 13. However, regarding the copy processing and the restoration processing, the user administrator can set an audit service level to, and input a restoration request to, the storage area in the user's own resource group 13, but is not conscious of the actual copy processing and restoration processing; and the copy processing and the restoration processing are executed according to the administrator's convenience. Incidentally, regarding the target person whose user type is the auditing organization, the user's own resource group which should be created for the user themselves does not exist; and, therefore, Null is recorded in the roles for the self resource group column 10042. However, since the auditing organization can refer to restored data which is an audit target, “Permit” is recorded in the read column 100433 and the restoration processing command column 100437. Incidentally, if the administrator executes restoration in response to a restoration request from the auditing organization, the user type of the auditing organization does not have to be defined.

According to the present embodiment, the aforementioned resource group management program 1013 permits all the operations made through the management computer 500 with regard to the storage areas belonging to the first resource group 13 and also permits the user host computer 300B to perform account management, input/output data to/from the storage areas in the first resource group 13, and input the restoration request. On the other hand, this resource group management program 1013 prohibits all the operations made through any element other than the management computer 500 and the host computer 300B. Also, the resource group management program 1013 permits all the operations made through the management computer 500 with regard to the storage areas belonging to the second resource group 13 and prohibits all the operations made through any element other than the management computer 500.

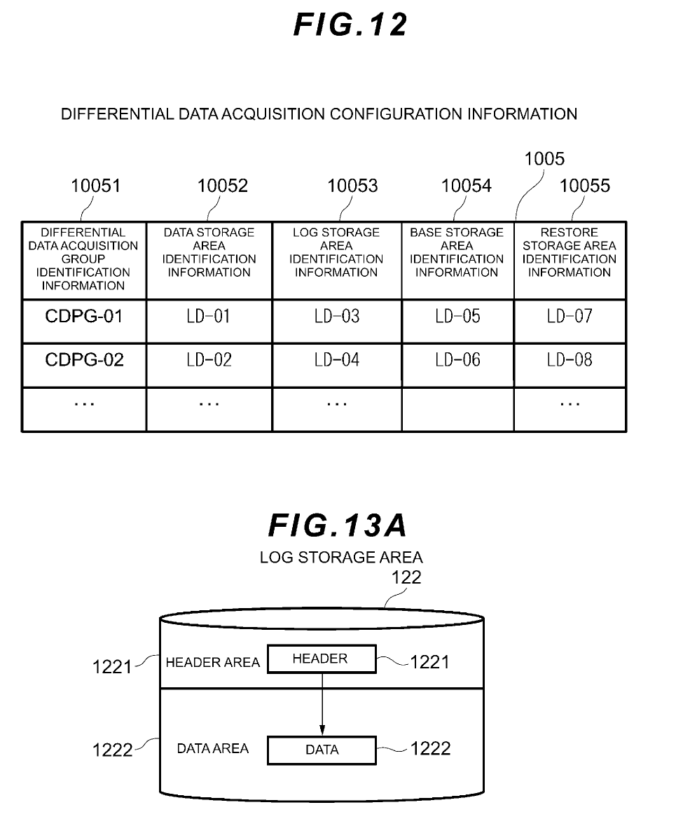

FIG. 12 shows an example configuration of the differential data acquisition configuration information 1005 included in the storage subsystem 100. The differential data acquisition configuration information 1005 includes differential data acquisition group identification information 10051, data storage area identification information 10052, log storage area identification information 10053, base storage area identification information 10054, and restore storage area identification information 10055. The differential data acquisition group identification information 10051 represents identification information about each differential data acquisition group 14 (such as CDPG-01).

The aforementioned differential data management program 1015 associates the following storage areas 11 with each other, as a resource group (such as the differential data acquisition group 14) indicated in the differential data acquisition group identification information 10051: a storage area 11 (such as the data storage area 121) indicated in the data storage area identification information 10052; the storage area 11 (such as the log storage area 122) indicated in the log storage area identification information 10053; a storage area 11 (such as the base storage area 123) indicated in the base storage area identification information 10054; and a storage area 11 (such as the restore storage area 124) set to the restore storage area identification information 10055; and a differential data management program 1015 manages them as one copy environment unit.

In the present embodiment, the data storage area 121, log storage area 122, base storage area 123, and restore storage area 124 are considered to be the storage areas 11 serving as the above-mentioned copy environment unit. However, the data storage area 121, the log storage area 122, the base storage area 123, and the restore storage area 124 may be a set of storage areas 11(HDP pool).

Regarding the differential data acquisition group 14 (such as CDPG-01) indicated in the differential data acquisition group identification information 10051, the data storage area identification information 10052 indicates the volume name of the data storage area 121 to which host write data is to be written. The log storage area identification information 10053 indicates the volume name (such as LD-03) of the log storage area 122 for storing the log information. The base storage area identification information 10054 indicates the volume name (such as LD-07) of the base storage area 123 for storing copy data of the data storage area 121 at a certain point in time in the past. The restore storage area identification information 10055 indicates the restore storage area 124 as a destination to which data at any point in time during a protection period is to be restored.

The present embodiment is configured so that, for example, data at a certain point in time in the past is restored while continuing acquisition of the differential data. Therefore, the base storage area 123 and the restore storage area 124 are prepared as separate storage areas. It should be noted that the above-described example configuration is the case where the after-journal method is used; and if the before-journal method is used, the base storage area 123 is unnecessary, so that the total capacity can be reduced by the capacity of that area.

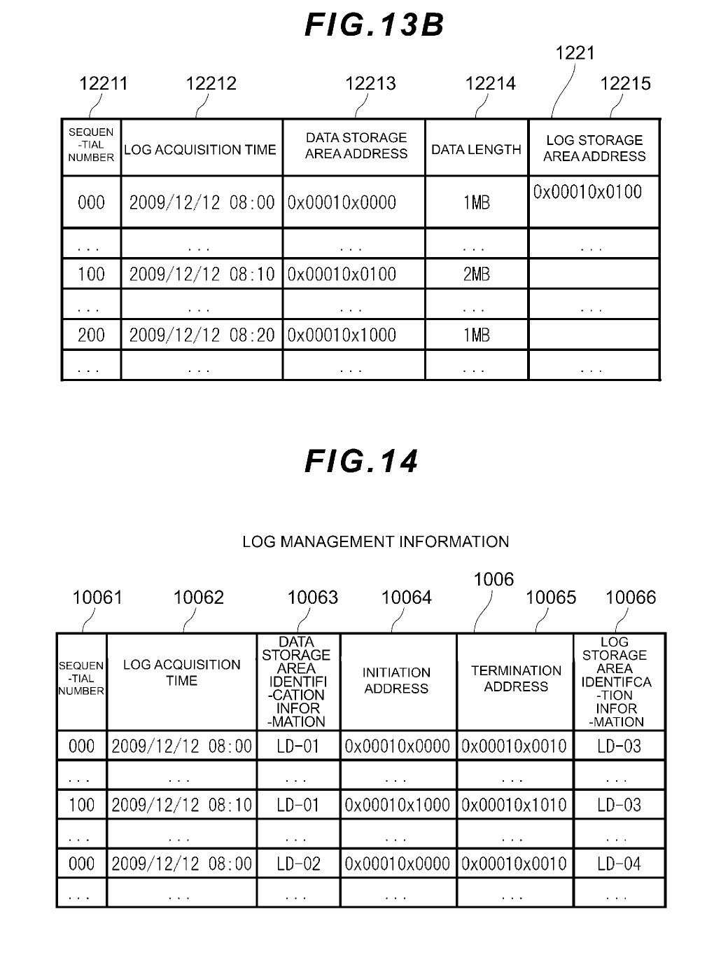

Each of FIGS. 13A and 13B shows an example of the detailed configuration of the log storage area 122 in the CDP configuration. The log storage area 122 includes a header area 1221 and a data area 1222 shown in FIG. 13A. The header area 1221 retains information about logs stored in the data area. The data area 1222 accumulates data (host write data) written by the host to a data storage area, which is a log creation target, as logs.

If there is host write data, the differential data recording program 1012 prepares the header 1221 in the header area shown in FIG. 13A. This differential data recording program 1012 registers, in the header 1221, a sequential number 12211, a log acquisition time 12212, a data storage area address 12213, data length 12214, and a log storage area address 12215, which are indicated in a table format as shown in FIG. 13B.

The sequential number 12211 indicates the order of the host write data. The log acquisition time 12212 indicates the time when the host write data was written. The data storage area address 12213 indicates address information about the host write data in the data storage area. The data length 12214 indicates the data length of the host write data. The log storage area address 12215 indicates the address of the data area 1222 where the host write data is stored.

The differential data recording program 1012 sets the address of the data storage area address 12213 as a starting address and stores the host write data in the data area 1222 with the data length indicated in the data length column 12214.

FIG. 14 shows an example configuration of the log management information 1006.

The log management information 1006 is managed in the storage subsystem 100. The log management information 1006 is managed in a storage area different from the aforementioned log storage area 122. This log management information 1006 includes a sequential number 10061, log acquisition time 10062, data storage area identification information 10063, a starting address 10064, an ending address 10065, and log storage area identification information 10066.

The differential data management program 1015 obtains header information about the log storage area 122 asynchronously and retains it as the log management in-formation 1006. The sequential number 10061 indicates the number of order of the host write data. The log acquisition time 10062 indicates the time when the host write data was written. The destination where the host write data is written corresponds to an area from the starting address 10064 to the ending address 10065. The log storage area identification information 10066 indicates identification information for identifying a log storage area where the log is stored. For example, if the sequential number is 000, it is shown that the log information about the storage area 11 (which corresponds to the aforementioned data storage area 121) corresponding to the volume name LD-01 is managed in the storage area 11 corresponding to the volume name LD-03.

If the above-described CDP configuration is used in the present embodiment, the storage subsystem 100 can restore data not only in the configuration having both the log storage area 122 and the log management information 1006, but also a configuration having the log storage area 122, but not having the log management information 1006. Furthermore, if the CPD configuration is not used as in a case of snapshots described later, the storage subsystem 100 may be in the configuration having the log management information 1006 instead of this log storage area 122.

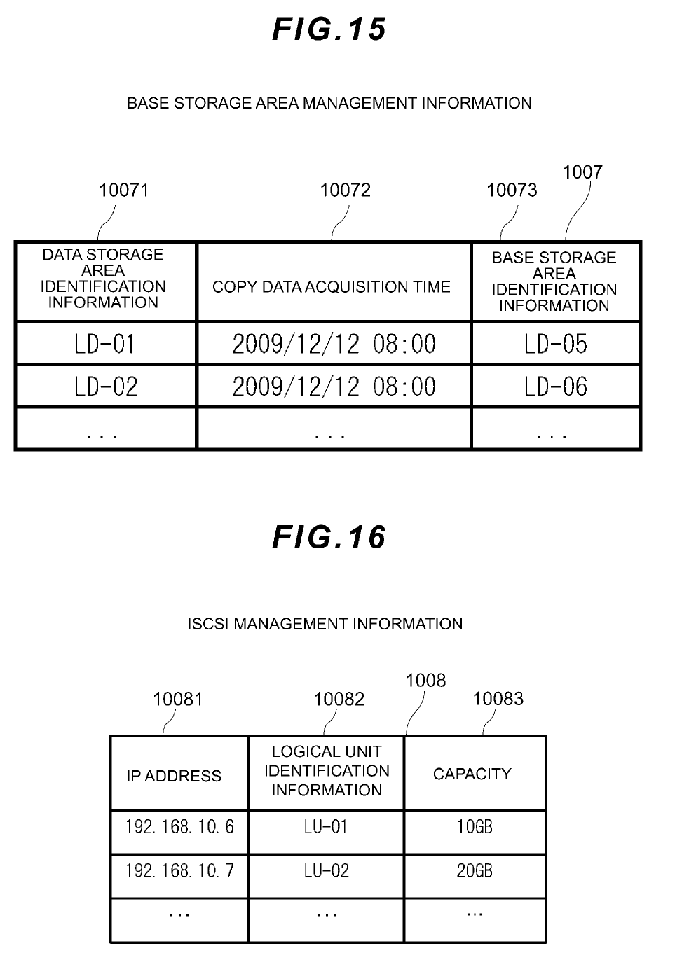

FIG. 15 shows an example configuration of the base storage area management information 1007. It should be noted that the base storage area management information 1007 is necessary when obtaining the after-journal. The base storage area management information 1007 is managed in the storage subsystem 100.

The base storage area management information 1007 includes data storage area identification information 10071, copy data acquisition time 10072, and base storage area identification information 10073. The differential data recording program 1012 copies data of the data storage area 121 corresponding to the volume name in the data storage area identification information 10071 to the base storage area 123 corresponding to the volume name in the base storage area identification information 10073 at the time set to the copy data acquisition time 10072 Timing of copying the data of the data storage area to the base storage area 123 may be starting time of a specified protection target period. In the normal CDP operation, an image of data may be copied instead of copying the data; however, since the data storage area 121 and the base storage area 123 belong to different resource groups in the present embodiment, the data cannot be shared.

FIG. 16 shows an example configuration of the iSCSI management information 1008. The iSCSI management information 1008 is managed in the storage subsystem 100. The iSCSI management information 1008 includes an IP address 10081, logical unit identification information 10082, and capacity 10083. The IP address 10081 indicates that it is assigned to the logical unit 10 which is set to the storage area identification information 10023. The capacity 10083 indicates the storage capacity of the logical unit 10.

According to the iSCSI management information 1008, the IP address set to the IP address 10081 is assigned to the data I/O interface associated with the logical unit 10 set to the logical unit identification information 10082.

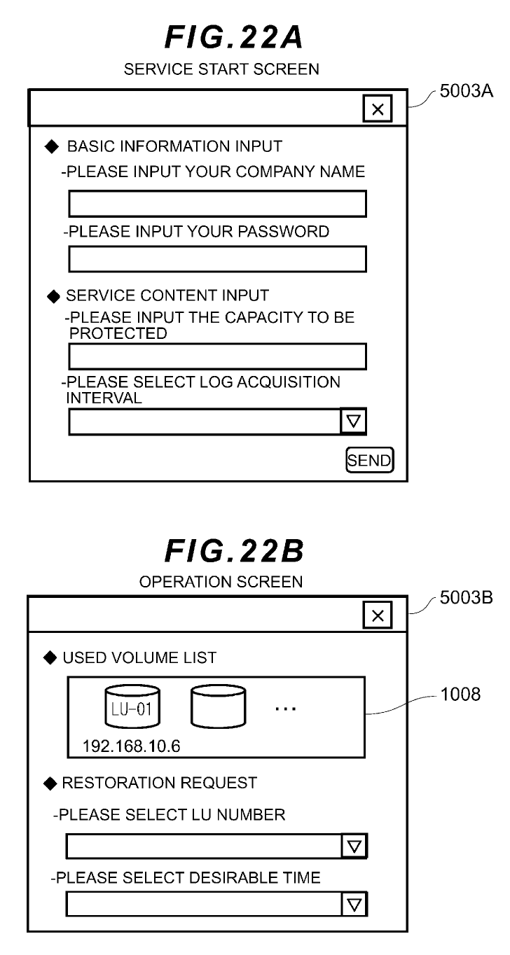

Specifically speaking, when the user host computer 300B at the user site 2A accesses the logical unit 10 via the network 4, access is made only to the IP address set to the IP address 10082. Incidentally, these pieces of control information are also displayed on the operation screen 5003A for the management computer 500 shown in FIG. 22A described later.

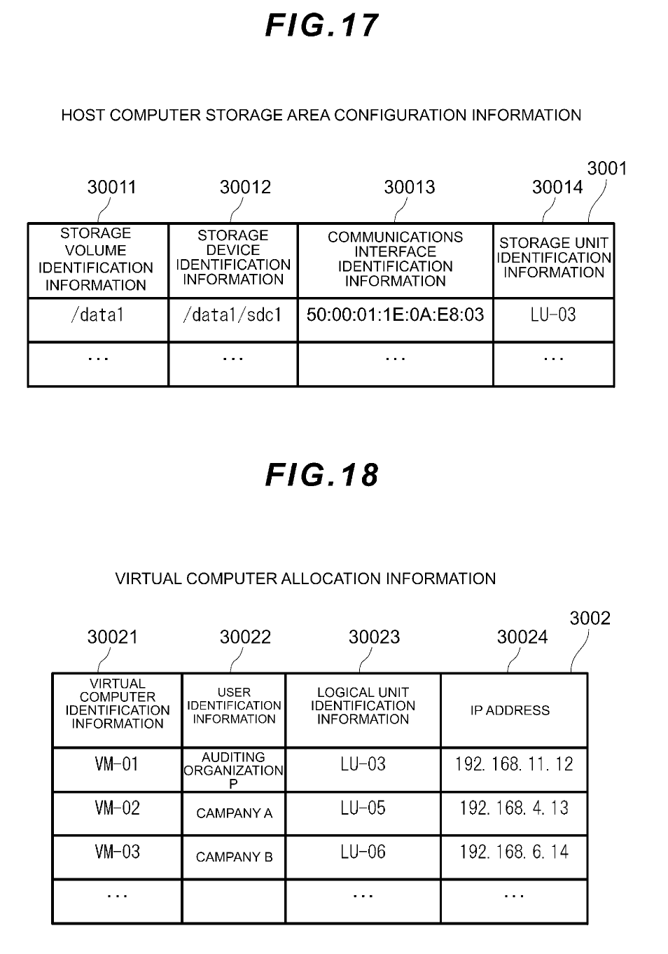

FIG. 17 shows an example configuration of the host computer storage area configuration information 3001. The host computer storage area configuration information 3001 is managed in the service provider host computer 300A. The host computer storage area configuration information 3001 includes storage volume identification information 30011, storage device identification information 30012, communication interface identification information 30013, and storage unit identification information 3014.

The file system for the service provider host computer 300A mounts a storage volume, which is set to the storage volume identification information 30011, to a storage device set to the storage device identification information 30012. The storage device is associated with a communication interface (such as the communications interface 140A) which is set to the communications interface identification information 30013, and this communications interface is associated with a storage unit which is set to the storage unit identification information 30014. Specifically speaking, an I/O request to the storage volume (such as /data) which is set to the storage volume identification information 30011 is executed with respect to the logical unit 10 (such as LU-03) identified base on the above-described correspondence relationship.

FIG. 18 shows an example configuration of the virtual computer allocation information 3002. The virtual computer allocation information 3002 is managed in the service provider host computer 300A and the management computer 500. The virtual computer allocation information 3002 includes virtual computer identification information 30021, user identification information 30022, logical unit identification information 30023, and an IP address 30024. The management computer 500 has the virtual computer creation indication program 5013, while the service provider host computer 300A has the virtual computer management program 3012.

The virtual computer creation indication program 5013 for the management computer 500 transmits a request message to the service provider host computer 300A to create the virtual computer 400. After receiving the request message, the virtual computer management program 3012 for the service provider host computer 300A creates the virtual computer 400 with the name indicated in the virtual computer identification information 30021 and assigns the IP address 30024 to this virtual computer 400 (the details of this processing will be described later in detail). Furthermore, the logical unit 10 corresponding to the LU number indicated in the logical unit identification information 30023 is mounted on this virtual computer 400. The LU number indicated in the logical unit identification information 30023 corresponds to the restore storage area 124 to which data at a certain point in time in the past, the application, and the operating system are to be restored.

According to the present embodiment, the virtual computer 400 is provided via the network 4 to the target person whose user type is indicated in the user identification information 30022. Specifically speaking, for example, the virtual computer 400 whose name is VM-01 is provided to the auditing organization site 3 whose name is “auditing organization P,” but not provided to any other sites.

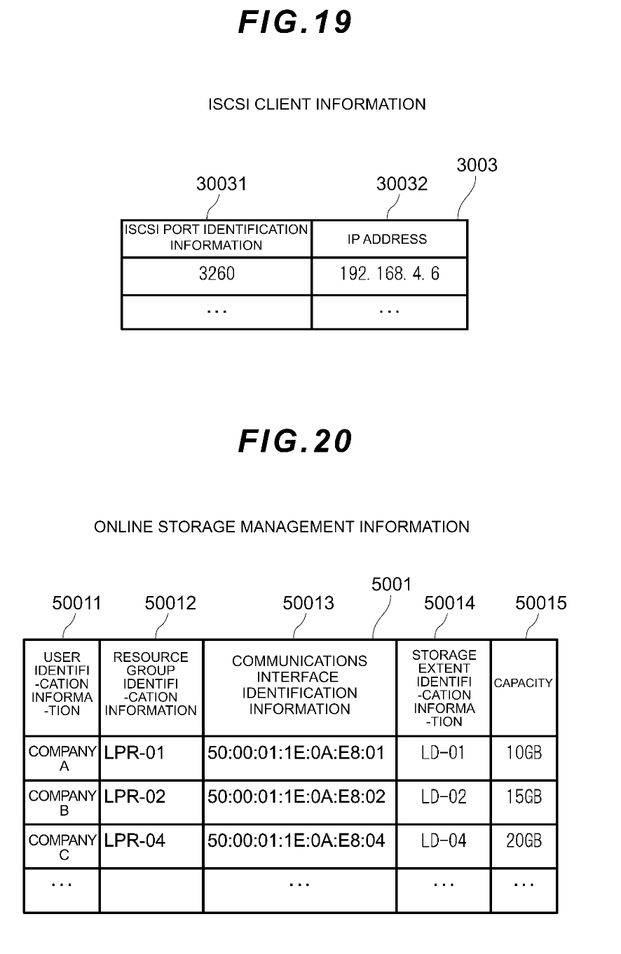

FIG. 19 shows an example configuration of the iSCSI client information 3003. The iSCSI client information 3003 is managed in the user host computer 300B. The iSCSI client information 3003 includes iSCSI port identification information 30031 and an IP address 300032. This iSCSI client information 3003 indicates, for example, the correspondence relationship between identification information about the iSCSI port for communication according to iSCSI protocol and the IP address.

The iSCSI management program 3013 assigns the IP address, which is set to the IP address 30032, to the iSCSI port whose identification information is set to the iSCSI port identification information 30031 so that the user site 2A will perform iSCSI communication with the storage subsystem 100 at the service provider site 3. As a result, the user host computer 300B can perform the iSCSI communication via the iSCSI port with the storage subsystem 100 at the location designated with the IP address.

FIG. 20 shows an example configuration of the online storage management information 5001 included in the management computer 500. The online storage management information 5001 includes user identification information 50011, resource group identification information 50012, communications interface identification information 50013, logical storage area identification information 50014, and capacity 50015. This online storage management information 5001 is control information for managing resource groups associated with the identification information about users to whom the online storage function is provided.

The user identification information 50011 is identification information for identifying each user. The resource group identification information 50012 indicates the name of a resource group corresponding to each user. The communications interface identification information 50013 indicates identification information about the communications interface 140A, 140B, 140C associated with that resource group. The logical storage area identification information 50014 indicates identification information about a storage area 11 belonging to that resource group. The capacity 50015 indicates the capacity of that storage area 11.

The storage area 11 whose volume name is indicated in the logical storage area identification information 50014 is associated with the resource group 13 whose resource group is indicated in the resource group identification information 50012. Such online storage management information 5001 shows to provide to the user whose identification information is indicated in the user identification information 50011 via the communications interface whose identification information is indicated in the communications interface identification information 50013,.

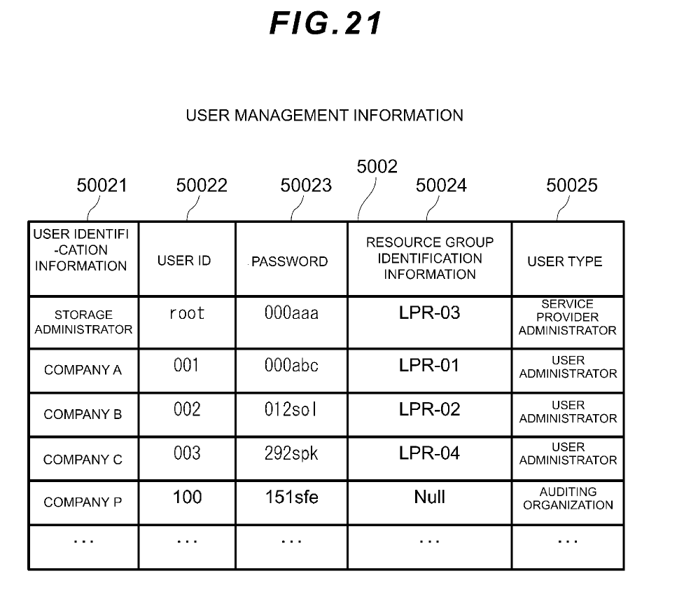

FIG. 21 shows an example configuration of the user management information 5002. The user management information 5002 is managed in the management computer 500. The user management information 5002 includes user identification information 50021, a user ID 50022, a password 50023, resource group identification information 50024, and a user type 50025.

The target person whose user type is indicated in the user identification information 50021 is authenticated based on the ID set to the user ID 50022 and a password set to the password 50023. According to such user management information 5002, each target person can execute the roles for a resource group whose name is indicated in the resource group identification information 50024. Incidentally, the details of operations each target person is permitted to perform are determined according to the user type set in each the user type 50025 as in the role management information shown in FIG. 11.

### (4) Operation Screen

FIGS. 22A and 22B show examples of an operation screen displayed on a display unit for the management computer 500. The management computer 500 displays the operation screen for selecting a data copy method in response to a restoration request based on the content of input made to obtain the log information. Examples of the operation screen can include a service start screen 5003A and an operation screen 5003B shown in FIGS. 22A and 22B, respectively.

The service start screen 5003A shown in FIG. 22A has input fields for inputting a company name and a password as basic information. Furthermore, the service start screen 5003A has input fields for inputting a desired service form such as the capacity to be protected and a log acquisition interval.

The online storage management program 5012 assigns the user ID to the user based on the basic information, which has been input, and manages the password by associating it with the user ID in the user management information 5002. Also, the online storage management program 5012 registers the copy mode in the user management information in accordance with the service content which has been input.

According to the input content, the auditing environment construction indication program 5011 for the management computer 500 makes a request to set a storage area in the storage subsystem 100 and construct the auditing environment there.

On the other hand, the operation screen 5003B shown in FIG. 22B has an used volume list and input fields for inputting information about a restoration request. The operation screen 5003B displays information extracted from the iSCSI management information 1008 relating to the user. The used volume list among the above-described information provides information about the relationship between the LU numbers of the logical units 10 using the online storage function and the IP addresses of the iSCSI ports in the storage subsystem 100, which are associated with the logical units 10. The operation screen 5003B also includes input fields for inputting the LU number and restoration time that the user wants to designate as a restoration request.

### (5) Resource Management Method for Storage System

Specific details of a resource management method for a storage system according to the present embodiment will be explained below, and the reference numerals to be given to resource groups may be omitted as appropriate, except when specific reference is made to, for example, FIG. 7.

(5-1) Resource Group Creation for Service Provider Administrator

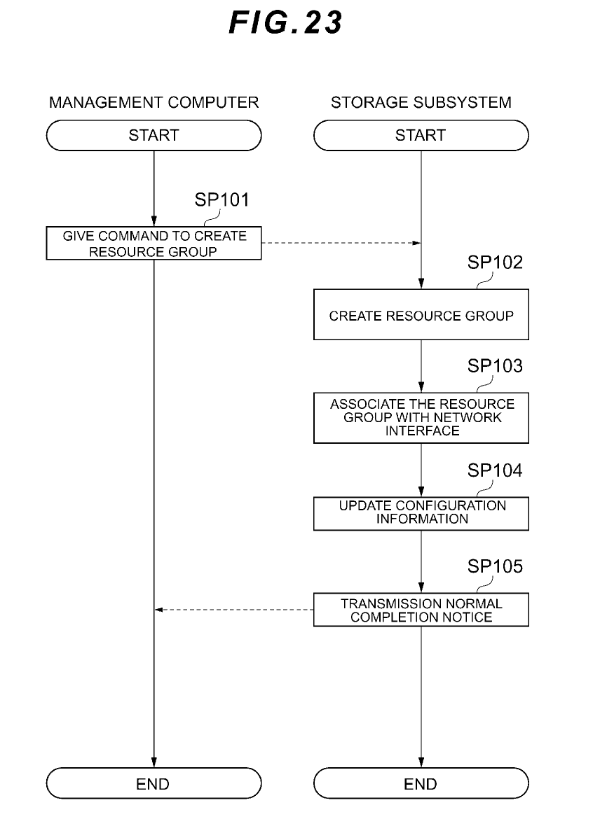

FIG. 23 shows an example of sequence of resource group creation processing for the service provider administrator. Execution of this resource group creation processing is started only when the target person whose use type is the service provider administrator inputs information to the operation screen 5003A for the administrator shown, for example, in FIG. 22A.

As explained earlier, the management computer 500 includes the resource group creation indication program 5010. This resource group creation indication program 5010 transmits a request message for resource group creation for, for example, the service provider administrator to the storage subsystem 100 (SP101). After the storage subsystem 100 receives this creation request, its resource group management program 1013 creates a new resource group and allocates the storage area 11 and a cache to that resource group (SP102). It should be noted that if there is an existing resource group, those allocated storage area 11 and cache have not been associated with, for example, any resource group.

The resource group management program 1013 sets a path to associate the logical unit 10 with the storage area 11, and then associates the communications interface with the resource group (SP103). The storage area configuration management program 1010 updates the logical unit configuration information 1002 and the resource group configuration information 1003 (SP104). The storage subsystem 100 transmits a normal completion notice to the management computer 500 (SP105).

The service provider administrator has the roles set to the role management information 1004 for a newly created resource group. It should be noted that the above-described processing may be executed as a sequence of processing following the resource group creation processing for the service provider administrator after the aforementioned request is made. The phrase “following the resource group creation processing for the service provider administrator” herein used means “following step SP211 described later.”

(5-2) Resource Group Creation for User Administrator

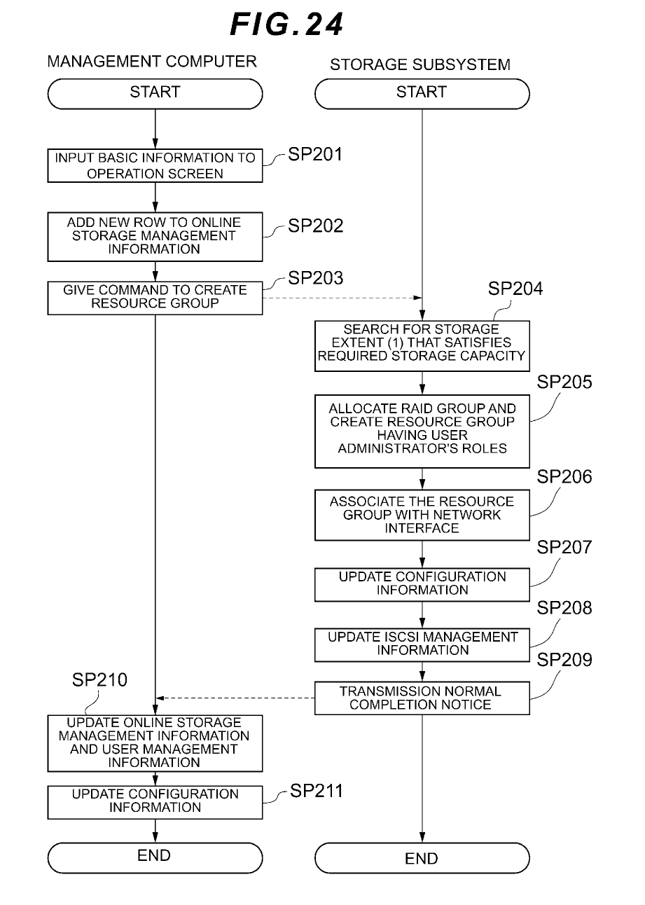

FIG. 24 shows a sequence of resource group creation processing for the user administrator. With the management computer 500, basic information such as the user name as well as service information such as the capacity to be protected and log acquisition are input on the operation screen 5003B (SP201). If it is found as a result of judgment based on the above input content that the resources for the storage subsystem 100 are deficient for the request or the user corresponding to the user name is inappropriate, the management computer 500 can return an error.

The online storage management program 5012 adds the above-described service information to a new row corresponding to the user ID in the online storage management information 5001 (SP202). Based on the service information added to the online storage management information 5001, the resource group creation indication program 5010 transmits a message request for resource group creation for the user administrator to the storage subsystem 100 by, for example, designating the user ID and the required storage capacity (SP203). After the storage subsystem 100 receives this resource group creation request, its storage area configuration management program 1010 searches for a storage area that satisfies the required storage capacity (which corresponds to the storage area (1) shown in the drawing) (SP204). Incidentally, the search range is limited to the range of storage areas which are not associated with any of existing resource groups.

The resource group management program 1013 creates a new resource group by designating a RAID group constituting the storage area (1) found by the search and a cache area (SP205). The resource group management program 1013 associates that resource group with the communications interface (SP206) and permits only the user ID, which has been input above, to access the communications interface.

The resource group management program 1013 updates the resource group configuration information 1003 shown in FIG. 10 based on the above-described content. The storage area configuration management program 1010 updates the logical unit configuration information 1002 shown in FIG. 9 based on the above-described content (SP207). The storage area configuration management program 1010 updates the iSCSI management information 1008 in order to disclose the logical unit 10 associated with the storage area 11 (corresponding to the storage area (1) in the drawing) to the specified user (SP208). If the update is performed normally, the storage subsystem 100 transmits a normal completion notice to the management computer 500 (SP209).

At the same time, the storage subsystem 100 also sends various pieces of control information for the iSCSI management information 1008 updated as described above to the management computer 500. After the management computer 500 receives the normal completion notice, its online storage management program 5012 updates the online storage management information 5001 and the user management information 5002 (SP210). With this management computer 500, the resource group management program 1013 updates the resource group configuration information 1003 and the storage area configuration management program 1010 updates the logical unit configuration information 1002 (SP211).

The above-described processing is executed for each user and resource groups for users are created as many as the number of the users. Incidentally, a resource group for the service provider administrator may be created only in association with the resource group creation processing for the user administrator and does not have to be created separately for users (the second user, the third user, and other users) other than the specified user (hereinafter sometimes referred to as the first user).

(5-3) Creation of Differential Data Recording Environment

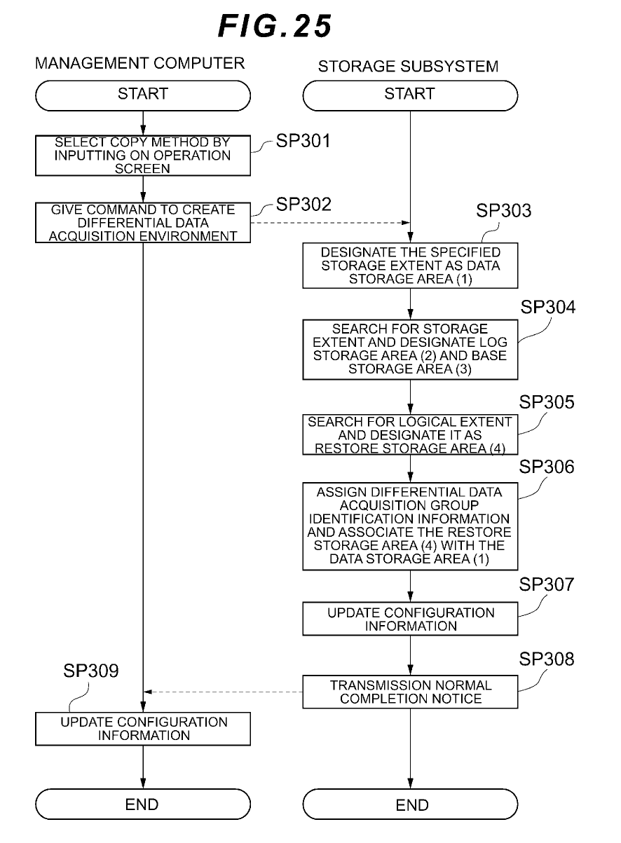

FIG. 25 shows a sequence of processing for creating the environment for recording differential data in the storage subsystem 100. In the present embodiment, the processing sequence will be explained by referring mainly to, by way of example, the CDP capable of restoring data at any point in time during a protection target period, as the differential data recording environment that can be audited; and such an audit environment can be set according to log acquisition conditions in the service content which is input to the operation screen 5003B. This processing is executed after the termination of the resource group creation processing. Incidentally, the present embodiment may be applied to, for example, snapshots described later instead of the above-described CDP. Furthermore, the present embodiment is not limited to the configuration for recording the differential data as described above, and the present embodiment may be configured so that log information for the entire data from a copy-source storage area 11 to a copy-destination storage area 11 may be obtained.

The management computer 500 has the online storage management program 5012 as described earlier, and this online storage management program 5012 selects a copy method according to the service content such as log acquisition interval, which has been input to the operation screen 5003A as described earlier (SP301). It is assumed here that “continuous” is selected on the operation screen 5003B with regard to the log acquisition, thereby giving a command to create the CDP environment.

The auditing environment construction indication program 5011 on the management computer 500 transmits a request message to the storage subsystem 100 to create the differential data recording setting (SP302).

After the storage subsystem 100 receives this request message, the differential data management program 1015 defines the storage area 11 designated in step SP204 as the data storage area 121 (corresponding to the data storage area (1) in the drawing) (SP303).

The differential data management program 1015 searches the storage areas 11, which are associated with the resource group 13 for the service provider administrator, which were created in step SP102, for a storage area 11 having the capacity equal to or larger than the capacity of the data storage area (1); and then defines that storage area 11 as the log storage area 122 (corresponding to the log storage area (2) in the drawing). Furthermore, the differential data management program 1015 searches for a storage area 11 in the same manner as in the case of the search for the log storage area (2); and defines that storage area 11 as the base storage area 123 (corresponding to the storage area (3) in the drawing) (SP304). As a result of this step SP304, it is possible to prevent unauthorized access to the log storage area 122 and the base storage area 123 by the user administrator.

The differential data management program 1015 searches the storage areas associated with the resource group for the administrator, which were created in step SP102, for a storage area 11 having the capacity equal to or larger than the capacity of the data storage area (1); and defines the storage area 11 as the restore storage area 124 (corresponding to the storage area (4) in the drawing) (SP305). If the capacity of storage areas to be used needs to be reduced as much as possible, the above-described step SP305 may be executed after the restoration request is made.

Next, the differential data management program 1015 issues a new differential data acquisition group 14 and associates the group 14 with the data storage area 121, log storage area 122, base storage area 123, and restore storage area 124 which were defined in steps SP303 to SP305 described above (SP306).

Specifically speaking, after receiving the request message from the management computer 500, the differential data management program 1015 creates the data storage area 121 so as to make it belong to the first resource group 13 and also creates the log storage area 122, the base storage area 123 for storing copy data of data at a certain point in time in the past, and the restore storage area 124 for restoring data based on the log information in the log storage area 122 and the copy data in the base storage area 123 in response to a restoration request, so as to make them belong to the second resource group 13. Then, the differential data management program 1015 further defines the data storage area 121, log storage area 122, base storage area 123, and restore storage area 124, which are created above, as one differential data acquisition unit, to the differential data acquisition group 14.

Subsequently, the differential data management program 1015 updates the differential data acquisition configuration information 1005 (SP307). At the same time, the resource group management program 1013 updates the resource group configuration information 1003. Then, the storage subsystem 100 transmits a normal completion notice to the management computer 500 (SP308). After the management computer 500 receives the normal completion notice, the resource group management program 1013 on the management computer 500 updates the resource group configuration information 1003, the differential data management program 1015 updates the differential data acquisition configuration information 1005, and the storage area configuration management program 1010 updates the logical unit configuration information 1002, respectively (SP309).

(5-3-1) Application to Snapshot

If the resource management method in the present embodiment is applied to snapshots, the resource group management program 1013 on the storage subsystem 100 defines a data storage area 121 to the first resource group 13 and also defines a storage area, in which differential data is to be stored, to the second resource group 13. When the user host computer 300B writes data to the data storage area 121, the storage subsystem 100 records the updated log information in the log storage area 122 created in the second resource group 13.

(5-3-2) Application to Backup Configuration

If the resource management method in the present embodiment is applied to the backup configuration, the resource group management program 1013 on the storage subsystem 100 defines a copy-source storage area 11 to the first resource group 13 and also defines a copy-destination storage area 11, to which data is backed up, to the second resource group 13. This storage subsystem 100 periodically copies data, which has been written by the user host computer 300B to the copy-source storage area, to the copy-destination storage area 11 defined to the second resource group 13.

(5-4) Online Storage Provision Start Processing

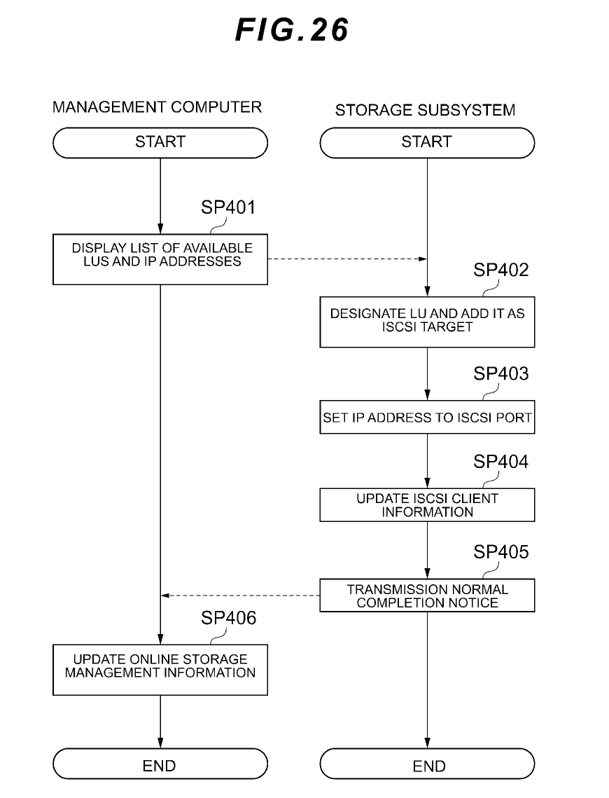

FIG. 26 shows an example of sequence of online storage provision start processing. This processing is executed after the termination of the above-described differential data recording environment creation processing.

The online storage management program 5012 on the management computer 500 displays the operation screen 5003B according to the basic information, which was input to the service start screen 5003A shown in FIG. 22A, based on the basic information. The online storage management program 5012 refers to the iSCSI management information 1008 updated in step SP210 and displays the LU numbers and the IP addresses of the logical units 10 that can be used by the target person corresponding to the basic information (SP401).

The user host computer 300B at the user site 2A displays the operation screen 5003B by reading the screen data via the network 4; and when specified operation such as input of the LU number is performed, the logical unit 10 is designated to the iSCSI port (SP402). The iSCSI management program 3013 sets the IP address to the iSCSI port (SP403). The iSCSI management program 3013 updates the iSCSI client information 3003 as shown in FIG. 19 (SP404). The above-described steps SP402 to SP404 may be performed by, for example, an iSCSI Initiator for Windows Server.

The user host computer 300B at the user site 2A transmits a normal completion notice to the management computer 500 (SP405). The online storage management program 5012 on the management computer 500 updates the online storage management information 5001 (SP406).

When the above-described processing is terminated, the storage subsystem 100 can provide the data storage area 121 via the network 4 by assigning the IP address to the iSCSI port associated with the data storage area 121. As a result, for example, the user host computer 300B connects to the storage area 11 corresponding to the storage area (1), that is, the data storage area 121 according to the iSCSI protocol. The user administrator can perform the roles defined for the user administrator in the role management information 1004 shown in FIG. 11 with regard to this data storage area 121 by operating the user host computer 300B. The user host computer 300B at the user site 2A uses the logical unit 10 by mounting it on the virtual computer 400.

(5-5) Data Write Processing

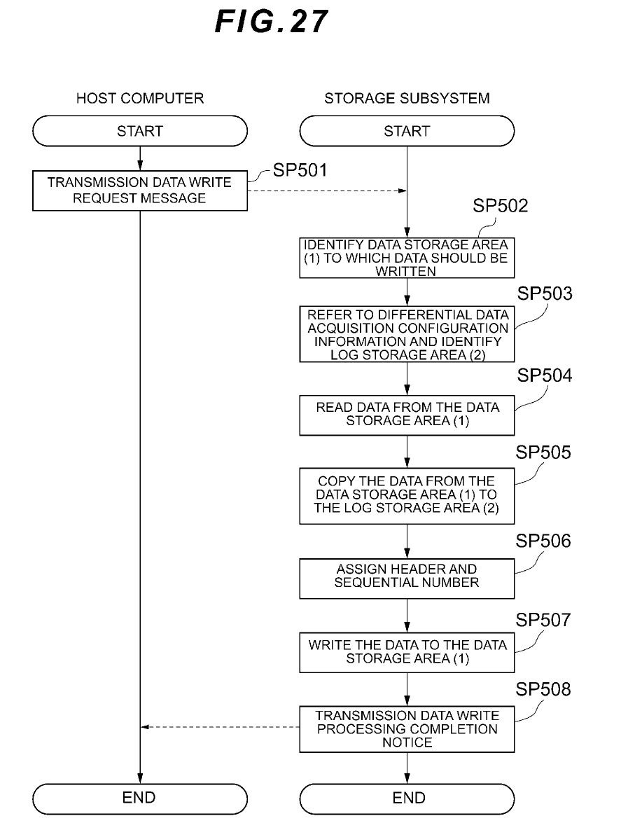

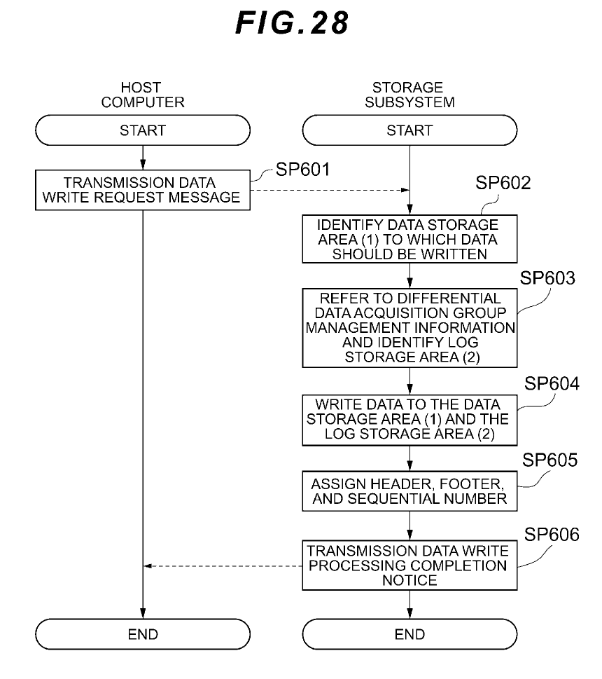

Each of FIG. 27 and FIG. 28 shows a sequence of data write processing in a case where the CPD method is used as a differential data acquisition method. Incidentally, if a snapshot method is selected as the differential data acquisition method, similar data write processing will be executed; however, since the header area 1221 as shown in FIG. 13A does not exist in the snapshots, no data will be written to the log management information.

(5-5-1) Before-Journal Method

FIG. 27 shows an example of a data write processing sequence when the before-journal method for the CDP is used. As described above, the user host computer 300B can recognize only the data storage area 121 (the data storage area (1)) belonging to the first resource group 13 from among the storage areas 11 in the storage subsystem 100. In this storage subsystem 100, the differential data management program 1015 records the log information in the log storage area 122 belonging to the second resource group 13 when the user host computer 300B writes data to the data storage area 121. Specific details of the processing will be explained below.

As described above, the data write request program 3010 on the user host computer 300B designates the logical unit 10 and transmits a data write request message to the storage subsystem 100 (SP501). The storage area configuration management program 1010 on the storage subsystem 100 refers to the logical unit configuration information 1002 (Referring to FIG. 9) and identifies a storage area 11 to which data should be written (corresponding to the data storage area (1) in the drawing) (SP502). The data storage area (1) mentioned above corresponds to the aforementioned data storage area 121.

The differential data management program 1015 refers to the differential data acquisition configuration information 1005 and identifies a storage area 11 corresponding to the log storage area (2) (which corresponds to the log storage area 122) (SP503). Next, the data writing program 1011 reads data from the data storage area 121 (corresponding to the data storage area (1) in the drawing) (SP504) and copies the read data to the log storage area 122 (corresponding to the log storage area (2) in the drawing) (SP505).

Next, the differential data management program 1015 gives a header and a sequential number of the log storage area 122 (the log storage area (2) in the drawing) (SP508). The data writing program 1011 writes the data to the data storage area 121 (corresponding to the data storage area (1) in the drawing) identified in step SP502 described above (SP507). Subsequently, the storage subsystem 100 transmits a normal completion notice to the management computer 500 (SP508). As a result, the differential data management program 1015 can migrate data across a plurality of resource groups 13 by referring to the differential data acquisition configuration information 1005 and thereby executing the CDP processing.

(5-5-2) After-Journal Method

FIG. 28 shows an example of a data write processing sequence when the after-journal method for the CDP is used. Like the above-described case where the before-journal method is used, the user host computer 300B can recognize only the data storage area 121 (corresponding to the data storage area (1)) because of the resource access limitation. In this data write processing, the differential data management program 1015 records the log information in the log storage area 122 belonging to the second resource group 13 at the time of data writing by the user host computer 300B. Specific details of the processing will be explained below.

The data write request program 3010 on the host computer 300 designates a logical unit 10 and transmits a data write request message to the storage subsystem 100 (SP601). After the storage subsystem 100 receives the data write request message, the storage area configuration management program 1010 refers to the logical unit configuration information 1002 and identifies the storage area 11 to which data should be written, that is, the data storage area 121 (corresponding to the data storage area (1) in the drawing) (SP602).

The differential data management program 1015 refers to the differential data acquisition configuration information 1005 (see FIG. 12), identifies a storage area 11 and sets it as the log storage area 122 (corresponding to the log storage area (2)) (SP603). The data writing program 1011 copies the data to the storage area 11 corresponding to the data storage area (1) (the data storage area 121) and also copies the data to the storage area 11 corresponding to the log storage area (2) (the log storage area 122) (SP604). The differential data management program 1015 gives a header, a footer, and a sequential number to the storage area 11 corresponding to the log storage area 122 (SP605). Subsequently, the storage subsystem 100 transmits a normal completion notice to the management computer 500 (SP606). As a result, the differential data management program 1015 can migrate data across a plurality of resource groups 13 by referring to the differential data acquisition configuration information 1005 and thereby executing the CDP processing.

(5-6) Data Restoration Method

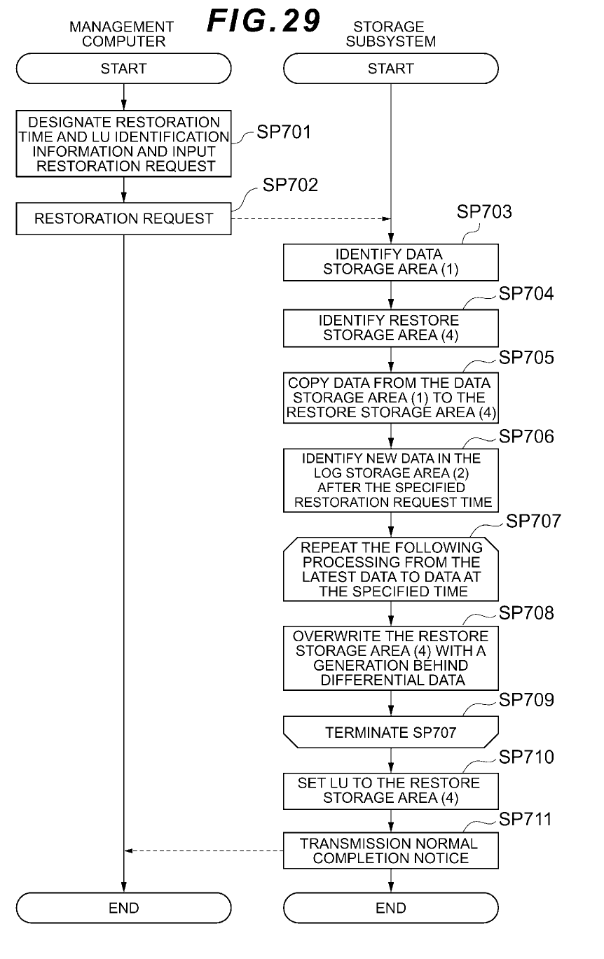

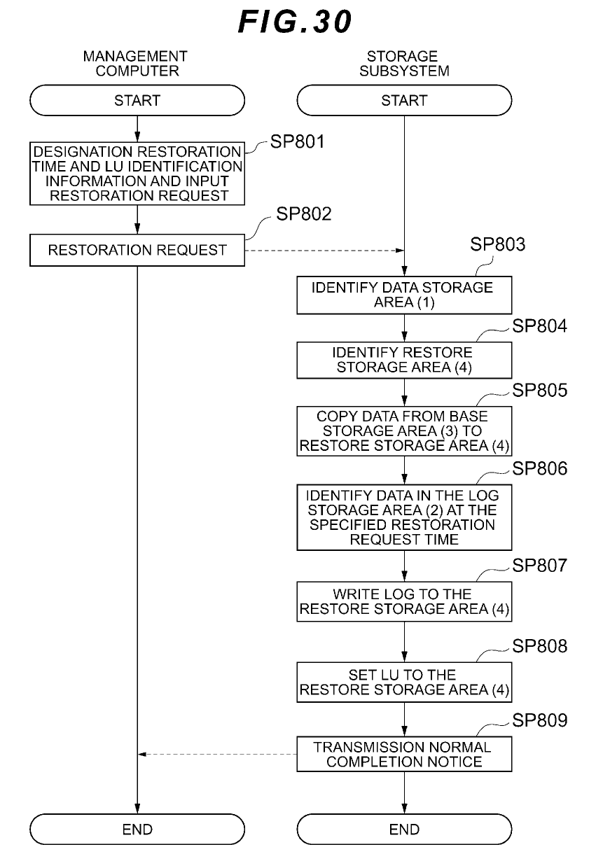

Each of FIG. 29 and FIG. 30 shows a data restoration processing sequence when the CDP is used as a differential data acquisition method. Firstly, the outline of the data restoration processing is as follows: after the storage subsystem 100 receives a restoration request from the management computer 500, the aforementioned differential data management program 1015 creates a restore storage area 124 so as to make it belong to the second resource group 13 for the service provider administrator; and the differential data management program 1015 further copies data of the data storage area 121 belonging to the first resource group 13 or data of the base storage area 123 belonging to the second resource group 13 to the restore storage area 124 and then applies a log stored in the log storage area 122. Specific details of the processing will be explained below.

(5-6-1) Before-Journal Method

FIG. 29 shows an example of a data restoration processing sequence when the before-journal method for the CDP is used. With the management computer 500, a restoration request is input on the operation screen 5003B (see FIG. 22B) by designating the LU number (identification information about the logical unit 10) and the restoration time (SP701). With this management computer 500, the data restoration program 1014 designates the input information in step SP701 and transmits a restoration request message to the storage subsystem 100 (SP702).

After the storage subsystem 100 receives the restoration request message, the storage area configuration management program 1010 refers to the logical unit configuration information 1002, identifies a storage area 11 which is set to the logical unit 10, and sets it as the data storage area 121 (corresponding to the storage area (1) in the drawing) (SP703). The differential data management program 1015 identifies a storage area 11 for restoration and sets it as the restore storage area 124 (corresponding to the restore storage area (4)) (SP704). Incidentally, if a new restore storage area 124 is to be created, the differential data management program 1015 specifies, for example, any of the storage areas 11 in the second resource group 13 (SP704).

The differential data management program 1015 copies data from the data storage area 121 (corresponding to the storage area (1) in the drawing) to the restore storage area 124 (corresponding to the restore storage area (4)) (SP705). Next, the differential data management program 1015 specifies the storage area 11 (corresponding to the log storage area (2)), in which the log information for the data storage area 121 is stored, specifies the restore storage area 124, and identifies data, which is newer than the restoration time (SP706).

The differential data management program 1015 repeats the following processing with regard to data from the latest data to data at the specified restoration time in step SP706 (SP707). Specifically speaking, the differential data management program 1015 overwrites data of the restore storage area 124 (corresponding to the restore storage area (4)) with data of the previous generation, that is, data with a smaller sequential number corresponding to each data (SP708). The storage area configuration management program 1010 sets a logical unit path (LU path) to that restore storage area 124 (SP710). The expression “set a logical unit path” means processing for enabling access to a specified storage area 11 by declaring that a path is set to a desirable storage area 11 which should be specified. Finally, the storage subsystem 100 transmits a normal completion notice to the management computer 500 (SP711).

If the general CDP method is used as the differential data acquisition method, data can be restored to a certain point in time in the past by applying the log information stored in the log storage area 122 to the data storage area 121. However, in the present embodiment, the differential data management program 1015 designates the storage area 11 corresponding to the restore storage area (4) defined to the second resource group 13, that is, the restore storage area 124 as the restoration destination because, for example, it is intended to continue the CPD operation and prohibit data migration from the second resource group to the first resource group in order to prevent manipulation of audit data by the user.

(5-6-2) After-Journal Method

FIG. 30 shows an example of a data restoration processing sequence when the after-journal method for the CDP is used. With the management computer 500, a restoration request is input to the operation screen 5003B (see FIG. 22B) by designating the restoration time and the LU number (identification information about the logical unit 10) (SP801). With this management computer 500, the data restoration program 1014 designates the input information in step SP701 and transmits a restoration request message to the storage subsystem 100 (SP802)

After the storage subsystem 100 receives the restoration request message, the storage area configuration management program 1010 refers to the logical unit configuration information 1002, identifies a storage area 11 corresponding to the logical unit 10, and sets it as the data storage area 121 (corresponding to the storage area (1) in the drawing) (SP803). The differential data management program 1015 identifies a storage area 11 as a restoration destination and sets it as the restore storage area 124 (corresponding to the restore storage area (4)) (SP804). Incidentally, if a new restore storage area 124 is to be created, the differential data management program 1015 specifies a storage area 11 belonging to the second resource group 13 (SP804).

The differential data management program 1015 copies data from the base storage area 123 (corresponding to the storage area (3) in the drawing) to the restore storage area 124 (corresponding to the restore storage area (4)) (SP805). Furthermore, the differential data management program 1015 specifies the log storage area 122 (corresponding to the log storage area (2) in the drawing), in which the log information for the data storage area 121 is stored, identifies data at the restoration time specified above (SP806), and writes the log information to the restore storage area 124 (corresponding to the restore storage area (4)) (SP807).

The storage area configuration management program 1010 sets a logical unit path to the restore storage area 124 (SP808). Finally, the storage subsystem 100 transmits a normal completion notice to the management computer 500 (SP809).

Incidentally, by the general CDP method, data can be restored to a certain point in time in the past by applying the log information to the data storage area 121. However, in the present embodiment, the restore storage area (4) defined to the second resource group 13, that is, the restore storage area 124 is designated as the restoration destination because it is intended to continue the CPD operation and prohibit data migration from the second resource group 13 to the first resource group 13 in order to prevent manipulation of audit data by the user.

(5-6-3) Application to Snapshot

It should be noted that almost the same data restoration processing will be executed if the snapshot method is used as the differential data acquisition method. Specifically speaking, after receiving a restoration request message from the management computer 500 as described above, the storage subsystem 100 creates the restore storage area 124 in the second resource group 13, reads data from the data storage area 121 in the first resource group 13, copies it to the restore storage area 124, and writes the log information. Incidentally, since a snapshot does not obtain a log every time the data storage area is updated, it is only possible to restore data at a point in time when the snapshot is obtained.

(5-6-4) Application to Backup Configuration

Also, almost the same data restoration processing will be executed if the resource management method according to the present embodiment is applied to a backup configuration. Specifically speaking, after receiving a restoration request message from the management computer 500 as described above, the storage subsystem 100 creates a storage area 11 for restoration in the second resource group 13, reads data from a copy-destination storage area 11, and copies it to the storage area 11 for restoration.

(5-7) Virtual Computer Provision Processing

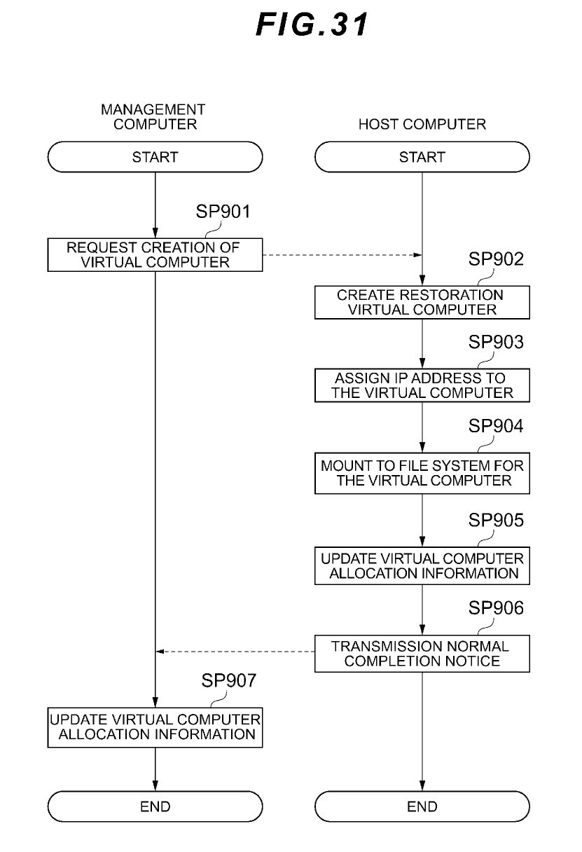

FIG. 31 shows an example of a processing sequence for providing the virtual computer 400 according to the present embodiment. This virtual computer 400 is a computer that is virtually formed in the service provider host computer 300A installed at the service provider site 1. The virtual computer 400 is a computer image for having data, which is restored as described later, browsed by, for example, the auditing organization site 3. Incidentally, this processing is executed after the termination of the restoration processing.

The target person who has been registered in the user management information 5002 makes the above-described request by inputting the LU number (identification information about the logical unit 10) and the restoration time to the operation screen 5003B shown in FIG. 22B and pressing a transmission button. Incidentally, if a person who has not been registered (for, example, an auditing host computer 300C for the auditing organization site 3) makes the request, the service provider administrator may make the request on behalf of this unregistered person by designating, for example, a logical unit 10.

The virtual computer creation indication program 5013 for the management computer 500 specifies the LU number of the logical unit 10, on which the virtual computer 400 is to be mounted, based on the input content such as the LU number and then transmits a request message to the service provider host computer 300A to create the virtual computer 400 (SP901).

After the service provider host computer 300A receives the request message, the virtual computer management program 3012 creates the virtual computer 400 as a new virtual computer image (SP902). The phrase “create the virtual computer” herein used means to virtually generate a computer image. In the present embodiment, the thus-generated virtual computer image is generally referred to as the virtual computer. The virtual computer management program 3012 has a file system operate on the created virtual computer 400. The virtual computer management program 3012 assigns the IP address to the virtual computer 400 (SP903).

The virtual computer management program 3012 mounts the logical unit 10 (for example, the restore storage area 124) corresponding to the LU number specified in step SP901 on the file system for the virtual computer 400 (SP904). This file system stores data used at the specified restoration time, an application for browsing this data, and an operating system for operating this application. Incidentally, this logical unit 10 is set for read-only use. The logical unit 10 is set for the read-only use because it is only necessary for this logical unit 10 to be capable of storing the audit target data and it is basically unnecessary to rewrite the data. The virtual computer management program 3012 updates the virtual computer allocation information 3002 shown in FIG. 18 at the service provider host computer 300A (SP905).

The virtual computer management program 3012 transmits a normal completion notice to the management computer 500 (SP906). After the management computer 500 receives the normal completion notice, the virtual computer creation indication program 5013 updates the virtual computer allocation information 3002 shown in FIG. 18 at the management computer 500 (SP907).

As a result, the virtual computer management program 3012 for the service provider host computer 300A can provide the audit target data, which can be browsed as set by the application operating on the operating system, to the auditing organization site 3 via the network 4. Even if the audit target data is of a special type, the auditing organization site 3 can browse the content of the virtual computer 400 without fail by connecting to the virtual computer 400 via the network 4. Therefore, a meaningful audit can be performed and the audit target data can be verified with certainty.

Incidentally, if the storage subsystem 100 according to the above-described embodiment receives a service start request from another user host computer 300B operated by another user (for example, the user of the user site 2B), it may execute the following processing: the resource group management program 1013 may create a third resource group regarding which access by the other user should be permitted, for example, a resource group named LRR-02 in FIG. 7, create a storage area 11 (such as LD-02), to which data is to be written by the user host computer 300B, that is, the data storage area 121 in that third resource group, and create a storage area 11 belonging to the second resource group 13 that is a storage area for recording past data.

### (6) Advantageous Effects of the Present Embodiment

As explained above, in the present embodiment the storage subsystem 100 receives a service start request from the management computer 500, the resource group management program 1013 creates the first resource group 13 as a resource group management step, regarding which access by the host computer 300B is permitted, and also creates the second resource group 13 regarding which access by the management computer 500 is permitted. Furthermore, as a storage area configuration management step, the storage area configuration management program 1010 on the storage subsystem 100 creates the data storage area 121, in which data is to be written by the host computer 300B, and makes the data storage area 121 belong to the first resource group 13, while it also creates the log storage area 122, in which past operations performed on the data storage area 121 by the host computer 300B are to be recorded, and makes the log storage area 122 belong to the second resource group 13.

As a result, if the user at the user site 2A has the host computer 300B write data to the data storage area in the storage subsystem 100 via the network 4, past operations of such data writing and other operations are stored in the log storage area 122 belonging to the second resource group 13 which is different from the resource group of the data storage area 121. Then, the user administrators at the user sites 2A, 2B are not permitted to access the log storage area 122 belonging to the second resource group 13, so that they cannot manipulate the log information in the log storage area 122 belonging to the different resource group as described above. As a result, it is possible to improve the reliability of the system auditing according to the present embodiment.

According to the present embodiment, the resource group management program 1013 permits all the operations made through the management computer 500 with regard to the storage areas belonging to the first resource group 13 and also permits the user host computer 300B to perform account management, read data from, and write data to, the storage areas in the first resource group 13, and input a restoration request, while it prohibits all the operations made through any element other than the management computer 500 and the user host computer 300B. Furthermore, the resource group management program 1013 permits all the operations made through the management computer 500 with regard to the storage areas belonging to the second resource group 13 and prohibits all the operations made through any element other than the management computer 500.

As a result, the management computer 500 can limit the storage areas which can be accessed by the user host computer 300B, and the operation content, so that it can control operations performed on the storage areas which should not be accessed by the user host computer 300B.

In the present embodiment, the management computer 500 displays the operation screen for selecting the data copy method in response to the restoration request and based on the content of input to obtain the log information. As a result, when obtaining the log information according to data recording in the data storage area 121, it is possible to set the data copy method in a desirable form.

After receiving a request from the management computer 500 to create the continuous data protection (CDP) environment according to the present embodiment, the storage subsystem 100 creates the data storage area 121 so as to make it belong to the first resource group 13, while it also creates the log storage area 122, the base storage area 123 for storing copy data of data at a certain point in time in the past, and the restore storage area 124 for restoring data in response to the restoration request and based on the log information in the log storage area 122 and the copy data in the base storage area 123, so as to make them belong to the second resource group 13.

According to the present embodiment, the storage subsystem 100 assigns the IP address to a port corresponding to the data storage area 121 and provides that data storage area 121 via the network 4. As a result, the storage subsystem 100 can keep, for example, the log storage area 122 belonging to the second resource group 13 confidential and shield it from the user host computer 300B, while it can permit the user host computer 300B to read data from, and write data to, the data storage area 121 via the network 4.

According to the present embodiment, the storage subsystem 100 has the differential data management program 1015 for recording the log information in the log storage area 122 belonging to the second resource group 13 when data from the user host computer 300B is written to the data storage area 121.

After the storage subsystem 100 receives a restoration request from the management computer 500, the differential data management program 1015 copies data of the data storage area 121 belonging to the first resource group 13 or data of the base storage area 123 belonging to the second resource group 13 to the restore storage area 124 according to the present embodiment.

The service provider site 1 has the service provider host computer 300A as another host computer according to the present embodiment. After this service provider host computer 300A receives a request from the management computer 500 to create a virtual computer, its virtual computer management program 3012 creates the virtual computer 400 as a virtual computer image and mounts the restore storage area 124 on this virtual computer 400. Data used at the specified restoration time, the application for browsing that data, and the operating system for operating this application are recorded in the restore storage area 124. This virtual computer management program 3012 provides the data, which can be browsed as set by the application operating on the operating system, via the network 4.

Accordingly, the virtual computer 400 has, for example, not only the audit target data, but also the application for browsing the data content and information about the operating system environment, all of which are recorded in the restore storage area 124. So, the application operating on the operating system makes it easier to browse the content of the audit target data recorded in the restore storage area 124. As a result, a person who wishes to browse the data can perform meaningful verification of the audit target data even if they do not have the environment or function enabling them to browse the audit target data.

After receiving a request from the management computer 500 to create the snapshot environment, the resource group management program 1013 defines the data storage area 121 to the first resource group 13 and also defines a storage area, to which differential data is to be stored, to the second resource group 13 according to the present embodiment.

When the user host computer 300B writes data to the data storage area 121, the storage subsystem 100 records the updated log information in the log storage area 122 created in the second resource group 13 according to the present embodiment.

After receiving a restoration request from the management computer 500, the storage subsystem 100 creates the restore storage area 124 in the second resource group 13, reads data from the storage area in the first resource group 13, copies it to the restore storage area 124, and writes the log information according to the present embodiment.

After receiving a request from the management computer 500 to create the backup environment, the resource group management program 1013 defines the copy-source storage area to the first resource group 13 and also defines the copy-destination storage area to the second resource group 13 according to the present embodiment.

According to the present embodiment, the storage subsystem 100 periodically copies the data, which is written by the user host computer 300B to the copy-source storage area, to the copy-destination storage area defined to the second resource group 13.

As a result, it is possible to prevent manipulation of data of the copy-destination storage area even by the user administrator because the copy-destination storage area belongs to the second resource group 13.

According to the present embodiment, after receiving the restoration request from the management computer 500, the storage subsystem 100 creates the restore storage area in the second resource group 13, reads data from the copy-destination storage area, and copies it to the restore storage area.

### (8) Other Embodiments

The above-described embodiments are examples given for the purpose of describing this invention, and it is not intended to limit the present invention only to these embodiments. Accordingly, this invention can be utilized in various ways unless the utilizations depart from the gist of the present invention. For example, processing sequences of various programs have been explained sequentially in the embodiments described above; however, the order of the processing sequences is not particularly limited to that described above. Therefore, unless any conflicting processing result is obtained, the order of processing may be rearranged or concurrent operations may be performed.

### REFERENCE SIGNS LIST

1 Service provider site

2A, 2B User sites

3 Auditing organization site

13 First resource group

14 Differential data acquisition group

100 Storage subsystem

300A Service provider site host computer

300B User host computer

300C Auditing host computer

400 Virtual computer

1001 Storage area configuration information

1002 Logical unit configuration information

1003 Resource group configuration information

1004 Role management information

1005 Differential data acquisition configuration information

1006 Log management information

1007 Base storage area management information

1008 ISCSI management information

1010 Storage area configuration management program

1011 Data writing program

1012 Differential data recording program

1013 Resource group management program

1014 Data restoration program

1015 Differential data management program

3001 Host computer storage area configuration information

3002 Virtual computer allocation information

3003 ISCSI client information

3010 Data write request program

3011 Data reference request program

3012 Virtual computer management program

3013 ISCSI management program

5001 Online storage management information

5002 User management information

5003A Service Start Screen

5003B Operation screen

5010 Resource group creation indication program

5011 Auditing environment construction indication control program

5012 Online storage management program

5013 Virtual computer creation indication program Claims

1. A storage system comprising:
a storage subsystem for providing a host computer operated by a user and a first administrator as a user administrator, with storage areas via a network; and
a management computer operated by a second administrator;
wherein the storage subsystem includes:
a resource group management unit for, after receiving a service start request from the management computer, creating a first resource group, regarding which access by the host computer is permitted, while creating a second resource group regarding which access by the management computer is permitted; and
a storage area configuration management unit for creating a data storage area, to which data is to be written by the host computer, and making the data storage area belong to the first resource group, while creating a log storage area, in which log information indicating past operation performed on the data storage area by the host computer is to be recorded, and making the log storage area belong to the second resource group.

2. The storage system according to claim 1, wherein regarding the storage area belonging to the first resource group, the resource group management unit permits all operations made through the management computer and also permits the host computer to perform account management, write data to, and read data from, the storage area in the first resource group, and input a restoration request, while it prohibits all operations made through any element other than the management computer and the host computer; and
regarding the storage area belonging to the second resource group, the resource group management unit permits all operations made through the management computer and prohibits all operations made through any element other than the management computer.

3. The storage system according to claim 2, wherein the management computer displays an operation screen for selecting a data copy method based on the content of input for acquisition of the log information in response to the restoration request.

4. The storage system according to claim 3, wherein after receiving a request from the management computer to create a continuous data protection environment, the storage subsystem creates the data storage area so as to make it belong to the first resource group, while it also creates the log storage area, a base storage area for storing copy data of data at certain time in the past, and a restore storage area for restoring data based on the log information in the log storage area and the copy data of the base storage area in response to the restoration request so as to make them belong to the second resource group.

5. The storage system according to claim 4, wherein the storage subsystem assigns an IP address to a port corresponding to the data storage area and provides the data storage area via the network.

6. The storage system according to claim 5, wherein the storage subsystem comprises a differential data management unit for recording the log information in the log storage area belonging to the second resource group when data from the host computer is written to the data storage area.

7. The storage system according to claim 6, wherein after the storage subsystem receives the restoration request from the management computer, the differential data management unit copies data from the data storage area belonging to the first resource group or the base storage area belonging to the second resource group to the restore storage area.

8. The storage system according to claim 7, further comprising another host computer equipped with a virtual computer management unit that, after receiving a request from the management computer to create a virtual computer, creates a virtual computer as a virtual computer image, mounts the restore storage area in the virtual computer, stores, in the restore storage area, data used at specified restoration time, an application for browsing the data, and an operating system for operating the application, and providing them via the network.

9. The storage system according to claim 3, wherein after receiving a request from the management computer to create a snapshot environment, the resource group management unit defines the data storage area to the first resource group, while it defines a storage area, in which differential data is to be stored, to the second resource group.

10. The storage system according to claim 9, wherein when the host computer writes data to the data storage area, the storage subsystem records the log information which is updated, in a storage area created in the second resource group.

11. The storage system according to claim 10, wherein after receiving the restoration request from the management computer, the storage subsystem creates a restore storage area in the second resource group, reads data from a data storage area in the first resource group, copies it to the restore storage area, and writes the log information.

12. The storage system according to claim 3, wherein after receiving a request from the management computer to create a backup environment, the resource group management unit defines a copy-source storage area to the first resource group and also defines a copy-destination storage area to the second resource group.

13. The storage system according to claim 12, wherein the storage subsystem periodically copies data, which is written by the host computer to the copy-source storage area, to the copy-destination storage area in the second resource group.

14. The storage system according to claim 13, wherein after receiving the restoration request from the management computer, the storage subsystem creates the restore storage area in the second resource group, reads data from the copy-destination storage area, and copies it to the restore storage area.

15. A resource management method for a storage system including:
a storage subsystem for providing a host computer operated by a user and a first administrator as the user administrator, with storage areas via a network; and
a management computer operated by a second administrator;
the resource management method comprising:
a resource group management step executed by the storage subsystem, after receiving a service start request from the management computer, for creating a first resource group, regarding which access by the host computer is permitted, while creating a second resource group regarding which access by the management computer is permitted; and
a storage area configuration management step executed by the storage subsystem for creating a data storage area, to which data is to be written by the host computer, and making the data storage area belong to the first resource group, while creating a log storage area, in which past operation performed on the data storage area by the host computer is to be recorded, and making the log storage area belong to the second resource group.
